(19) United States
(12) Patent Application Publication
(10) Pub. No.: US 2019/0015940 A1
(43) Pub. Date: Jan. 17, 2019

(54) COMPUTER CONTROLLABLE XYZ MACHINE

(71) Applicant: GARY MAIER, Lutz, FL (US)

(72) Inventor: GARY MAIER, Lutz, FL (US)

(21) Appl. No.: 16/033,374

(22) Filed: Jul. 12, 2018

Related U.S. Application Data
(60) Provisional application No. 62/531,927, filed on Jul. 13, 2017.
(60) Provisional application No. 62/581,129, filed on Nov. 3, 2017.

(51) Int. Cl. B23Q 3/00; B23Q 7/00; G05B 19/402; G05B 19/4061

(52) U.S. Cl. CPC B23Q 3/005; G05B 19/4061; G05B 19/402; B23Q 7/008

(57) ABSTRACT

Examples disclosed herein relate to a machining device including one or more beams attached to a surface; a platform coupled to the one or more beams; a tool support element coupled to the platform; a first movement device which may move the platform in a first direction; a second movement device which may move the platform in a second direction; and a third movement device which may move the tool support element in a third direction.

### REFERENCE

The present application claims priority to U.S. provisional patent application Ser. No. 62/531,927, entitled “COMPUTER CONTROLLABLE XYZ MACHINE”, filed on Jul. 13, 2017 and U.S. provisional patent application Ser. No. 62/581,129, entitled “TORCH CHASING SYSTEM”, filed on Nov. 3, 2017, which are both incorporated in their entirety herein by reference.

### FIELD

The subject matter disclosed herein relates to a computer-controllable XYZ machine. The end-effector may be a plasma cutter, a welder, a router, a paint sprayer, or other devices which benefit from being controlled in any XYZ space.

### INFORMATION

The machining industry has numerous ways to manipulate one or more metals, materials, and/or fibers. This disclosure highlights enhanced devices, methods, and systems for manipulating one or more metals, materials, and/or fibers.

### BRIEF DESCRIPTION OF THE FIGURES

Non-limiting and non-exhaustive examples will be described with reference to the following figures, wherein like reference numerals refer to like parts throughout the various figures.

FIG. 1 is an illustration of a machining system without a table which may be used for plasma cutter, a welder, a router, a paint sprayer, or other devices, according to various embodiments.

FIG. 2 is another illustration of a machining system without a table which may be used for plasma cutter, a welder, a router, a paint sprayer, or other devices, according to various embodiments.

FIG. 3 is an illustration of a machining system with a table and a tool chaser (e.g., torch chaser, cutting chaser, etc.) which may be used for plasma cutter, a welder, a router, a paint sprayer, or other devices, according to various embodiments.

FIG. 4 is an illustration of a machining system with a tool chaser (e.g., torch chaser, cutting chaser, etc.) and without a table which may be used for plasma cutter, a welder, a router, a paint sprayer, or other devices, according to various embodiments.

FIG. 5 is an illustration of a machining system with a table and a tool chaser (e.g., torch chaser, cutting chaser, etc.) which may be used for plasma cutter, a welder, a router, a paint sprayer, or other devices, according to various embodiments.

FIG. 6 is an illustration of a machining system without a table which may be used for plasma cutter, a welder, a router, a paint sprayer, or other devices, according to various embodiments.

FIG. 7 is an illustration of a machining system without a table which may be used for plasma cutter, a welder, a router, a paint sprayer, or other devices, according to various embodiments.

FIG. 8 is an illustration of a machining system without a table which may be used for plasma cutter, a welder, a router, a paint sprayer, or other devices, according to various embodiments.

FIG. 9 is an illustration of a vacuum system, according to an embodiment.

FIG. 10 is another illustration of a vacuum system, according to an embodiment.

FIG. 11A is an illustration of a machining system with a table which may be used for plasma cutter, a welder, a router, a paint sprayer, or other devices, according to various embodiments.

FIG. 11B is an illustration of a machining system with a table which may be used for plasma cutter, a welder, a router, a paint sprayer, or other devices, according to various embodiments.

FIG. 12A is an illustration of a machining system with a table and a tool chaser (e.g., torch chaser, cutting chaser, etc.) which may be used for plasma cutter, a welder, a router, a paint sprayer, or other devices, according to various embodiments.

FIG. 12B is an illustration of a machining system with a table and a tool chaser (e.g., torch chaser, cutting chaser, etc.) which may be used for plasma cutter, a welder, a router, a paint sprayer, or other devices, according to various embodiments.

FIG. 12C is an illustration of a machining system with a table and a tool chaser (e.g., torch chaser, cutting chaser, etc.) which may be used for plasma cutter, a welder, a router, a paint sprayer, or other devices, according to various embodiments.

FIG. 13 is a flow chart, according to one embodiment.

FIG. 14 is a flow chart, according to one embodiment.

FIG. 15 is a flow chart, according to one embodiment.

FIG. 16 is a flow chart, according to one embodiment.

FIG. 17 is a block diagram, according to one embodiment.

FIG. 18 is an illustration of a plasma JIG, according to one embodiment.

FIG. 19 is an illustration of a folding work table, according to one embodiment.

FIG. 20 is an illustration of a half-table working table, according to one embodiment.

FIG. 21 is an illustration of folding work table, according to one embodiment.

FIG. 22 is another illustration of folding work table, according to one embodiment.

FIG. 23 is an illustration of an XYZ machine system including a half-table folding table and a folding table, according to one embodiment.

### DETAILED DESCRIPTION

This disclosure relates to a computer-controllable XYZ machine. The end-effector may be a plasma cutter, a welder, a router, a paint sprayer, or other devices which benefit from being controlled in any XYZ space. This embodiment describes the machine using a plasma cutter as its end-effector.

In one example, the cutting machine does not need a table (e.g., is a non-table-centric machine). Conventionally, a cutting machine needs a table as it foundation which results in the cutting machine being limited by the surface area of the table. Further, the table is costly and requires one or more load-bearing structure in order to hold up the material being worked on (e.g., metal work).

Walls

In various embodiments, the system utilizes a structure that is not actually a component of the system itself. Generally, a wall of an existing structure is used, however fabrications which act as walls (e.g. a surface perpendicular to the ground) are used also. Such fabrications may be standalone, wheeled, or a combination. Also, suitable surfaces include vehicle interiors or exteriors, as well as vehicle trailers.

Tables

In various embodiments, in order to maximize the usefulness of the machine, the traditional table-centric design has been abandoned. Because the system is fixed to a surface it can operate with the normal structure of a table. Table structures are not only heavy and expensive; they are very restrictive and prevent a free and open machining or manufacturing environment. The tables in this design are foldable and provide only a structure into which jigs are placed. Examples of simple jigs may be a thick wooden flat board providing for wood routing, or a cross-hatched metal slat arrangement allowing for welding or plasma cutting. The tables fold to allow minimizing space consumption in several possible configurations, or folded completely so as to allow the space under the machine's envelope to be used for other purposes, including work which would otherwise not be practical to put on a table. In garage installations, the folding tables allow a vehicle to be parked inside the envelope of the machine. In one embodiment, the tables are constructed as 4 foot by 2 foot rectangles. Four such rectangles are used in total. This provides 8 feet by 4 feet, 4 feet by 4 feet, 8 feet by 2 feet, and 4 feet by 2 feet. Adjustable wall mounts act as legs for one side, and adjustable floor legs are used on the adjacent side.

Tool Chaser

In various embodiments, a tool chaser operates under the work table, or under the work piece. The tool chaser is a computer-controlled apparatus which is programmed in such a way that it can intercept debris (gasses, particulates, dust, chips, tailings, etc.) being created by the tool installed in the tool holder. It does not necessarily travel directly under the tool, instead it is programmed to capture debris and may be traveling at an offset with respect to the tool. The tool chaser's capture is performed by computer-controlled placement of a vacuum, a vessel containing a liquid, or an empty vessel, or a combination. Many tools benefit from debris capture under the work being performed, however existing solutions require custom tables to provide water trays or vacuum chambers. These are very costly to construct, operate and maintain. Not only does the tool chaser extend the functionality to all work and tool types, but, as in this embodiment, the vessel used for capture is the size of a 1-gallon paint can. This drastically reduces electrical and maintenance costs.

Vacuum

Traditional vacuum systems drape vacuum hose over a machine in order place the vacuum effect near the tool. This requires an extensive number of feet of unwieldy vacuum hose in order to accommodate the full traveling abilities of a machine. In various embodiments, the disclosed system utilizes a slinky-style hose which readily collapses and expands (unlike traditional hoses). Using a cable, the vacuum hose is kept captive in its travel thereby reducing by as much as half of the normally required vacuum hose required. The cable is buried within the vacuum hose and provides support for the hose to expand and collapse in a controlled fashion. The vacuum hose attachments provide for seals to maintain vacuum throughout the system.

Tool Chaser/Vacuum

When the aforementioned vacuum system and the aforementioned tool chaser are combined, the user of the system will benefit from a debris capture system that currently does not exist in any form. Debris is capture from above and below the work and tool with a drastically reduced cost of operation and maintenance.

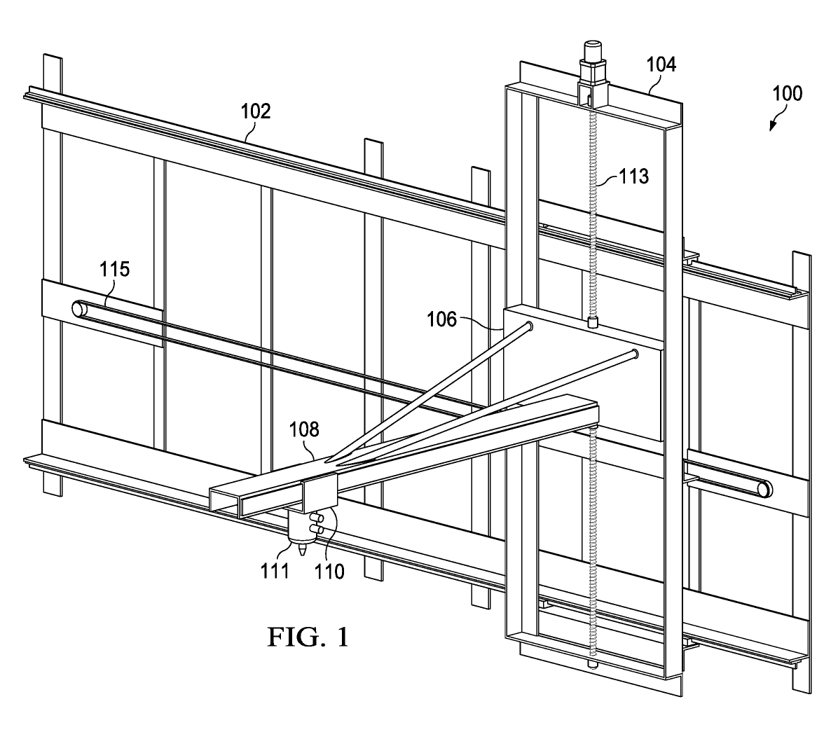

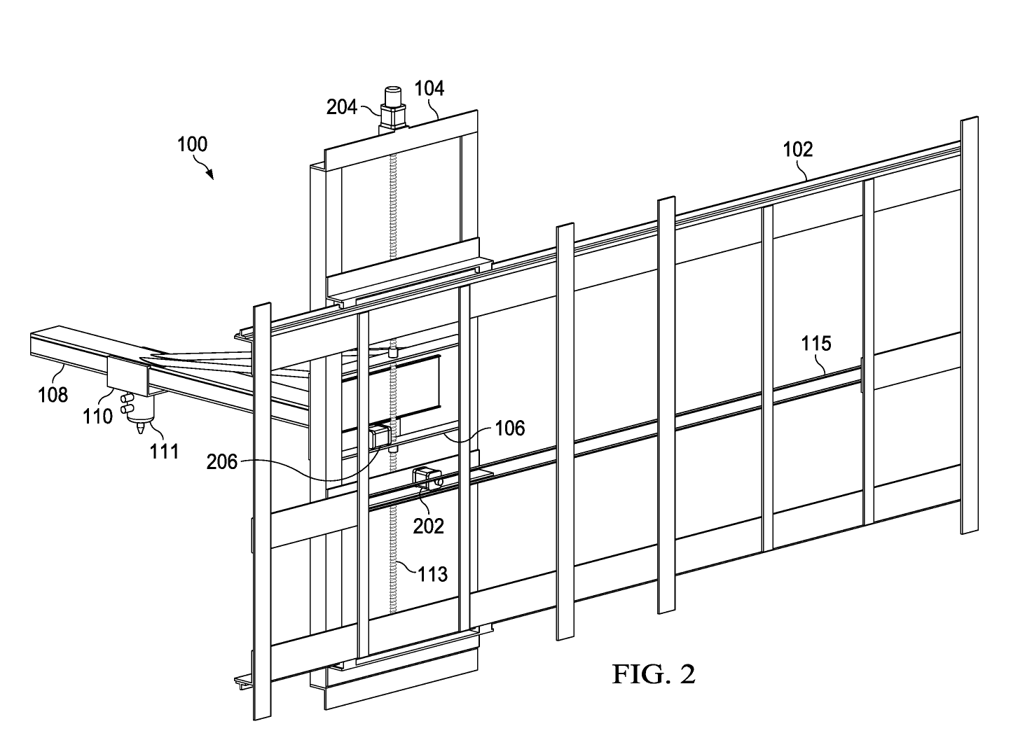

In one embodiment of the cutting system 100 shown in FIG. 1, one or more X-axis bars 102 attach to one or more surfaces (e.g., vertical surfaces, horizontal surfaces, a ground surface, and/or a ceiling surface. In this example, the one or more X-axis bars 102 are attached to a vertical surface (e.g., a wall). Further, the cutting system 100 may include one or more Z-axis frames 104 which attach to the one or more X-axis bars 102. In this example, the one or more Z-axis frames 104 are capable of movement along the one or more X-axis bars 102 via an X-axis motor 202 (see FIG. 2). In addition, the cutting system 100 may include a Z-saddle which stabilizes a Z-motor 204 (see FIG. 2). The cutting system 100 may also include one or more Y-axis bars 108 which are attached to at least one of the Z-saddle 106, the Z motor 204, and/or the one or more Z-axis frames 104. In one example, the Y-axis bars 108 include one or more tool holders 110. The one or more tool holders 110 are utilized to attach one or more tools 111 (e.g., plasma cutting machine, etc.). The one or more tools 111 may be any end-effectors. The end-effectors may include drilling spindle, milling spindle, abrasive-blasting nozzle, a drag-knife, a hot-wire knife, a treading spindle, a tapping spindle, any other know end-effectors, and/or any combination thereof. The one or more tool holders 110 may be a multiple tool holders that can hold one or more tools simultaneously. In one example, one or more tools may rotate into a working position which may be accomplished manually and/or via motors utilizing computer controls (e.g., motors, sensors, and/or processors).

FIG. 2 shows the cutting system 100 with a Y-motor 206 which allows for movement along the Y-axis of the cutting system 100, the Z-motor 204 which allows for movement along the Z-axis of the cutting system 100, and the X-motor 202 which allows for movement along the X-axis of the cutting system 100.

In various examples, the cutting system 100 may be constructed of metal, plastic, wood, ceramics, polymers, and/or combination thereof. In one example, the cutting system 100 parts are made up of mental. For cost savings and simplicity, the current embodiment uses easily-obtained steel angle iron to completely construct the machine.

In various examples, the cutting system 100 may allow for outrageous (extreme, flexible, productive, etc.) Z-directional movement and/or travel. In one example, the Z travel's (movement, etc.) primary use is to allow the Y Axis to be moved up enough to allow objects to be located underneath it (e.g., a car to be parked underneath the cutting system 100). It also lends itself to interesting work: metal can be cut while still on a trailer or in the back of a pickup. It allows large objects to be moved under the cutter/welder. If a wood router is used as the tool, it allows existing furniture to be customized.

In another example, normally the Z axis of any computer numerical control (“CNC”) machine is the shortest-moving axis. For example, a CNC machine with 22″ of X, typically has 16″ of Y, and 8 to 12″ of Z. Being able to adjust the machine dynamically to fit the work is extremely useful. The way it's accomplished today is by using the cutter/welder/router by hand. The CNC machines are only used when the project is in its infancy and still consists of flat components.

In another example, the cutting system 100 may be wall mounted. This has the obvious benefits of space-saving and massive cost-reduction. In conjunction with the Z travel and the low wall profile the machine can practically disappear (requires minimal storage space) when not in use. Not having a fixed table saves a fortune in metal given that tables must hold 500-1000 lbs. to be useful. Also by having no table, the space in the machine's working envelope can be used for parking or for further assembly of a project.

In one example, the cutting system 100 may be used to cut a sunroof into a vehicle. In this example, the vehicle is driven underneath the cutting system 100 where the cutting system 100 creates a sunroof and/or any other element into the vehicle. In another example, one or more objects (e.g., heavy, light, etc.) may be positioned underneath the cutting system 100 and/or Y-axis bars 108 and/or tools located in the one or more tool holders 110 to be worked on by the cutting system 100.

Please note that this disclosure includes controlling the cutting system 100 with one or more processors to automatically cut, craft, and/or modify any object and/or element.

In another example, the one or more Y-axis bars 108 may swing towards the one or more of the Z-axis frame 104 and/or the one or more X-axis bars 102. This may be done for storage purposes. Further, the one or more Y-axis bars 108 may move up the one or more of the Z-axis frame 104 to a storage point. In addition, the one or more Y-axis bars 108 may move towards the one or more X-axis bars 102. In another example, the one or more Y-axis bars 108, the one or more of the Z-axis frame 104 and/or the one or more X-axis bars 102 may consolidate towards each other for compact storage. In another example, the one or more Y-axis bars 108 and the one or more of the Z-axis frame 104 may consolidate towards each other for compact storage while the one or more X-axis bars 102 stay stationary.

### VARIOUS EXAMPLES

Any existing structure that otherwise could not be lifted onto a traditional table either because of weight or dimension. Materials can be cut or welded while still on a delivery trailer or inside the bed of truck. Modifications to existing weldments previously had to be done by handheld cutters or welders. In conjunction with a swiveling head, the end-effector can be oriented in ways never before considered. Coupled with the massive Z axis cuts and welds can be performed in the Z axis—very novel given the X and Y are the project's usual space while the Z is only to downwardly position an end-effector. The unit can be thought of as ‘cubic’ versus the traditional X/Y flat plane.

All of these examples in this disclosure may be combined in any manner. In other words, a first element in example 1 may be combined with a second element and a third element of example 2. Further, a first element in example 1 may be combined with a third element of example 2, a fifth element of example n−1, and/or an n element from an nth example. Further, all directional references may be interchanged. For example, a reference to an element and/or feature completing a task in the x-plane may be replaced by the element and/or feature completing the task in the y-plane and/or the z-plane.

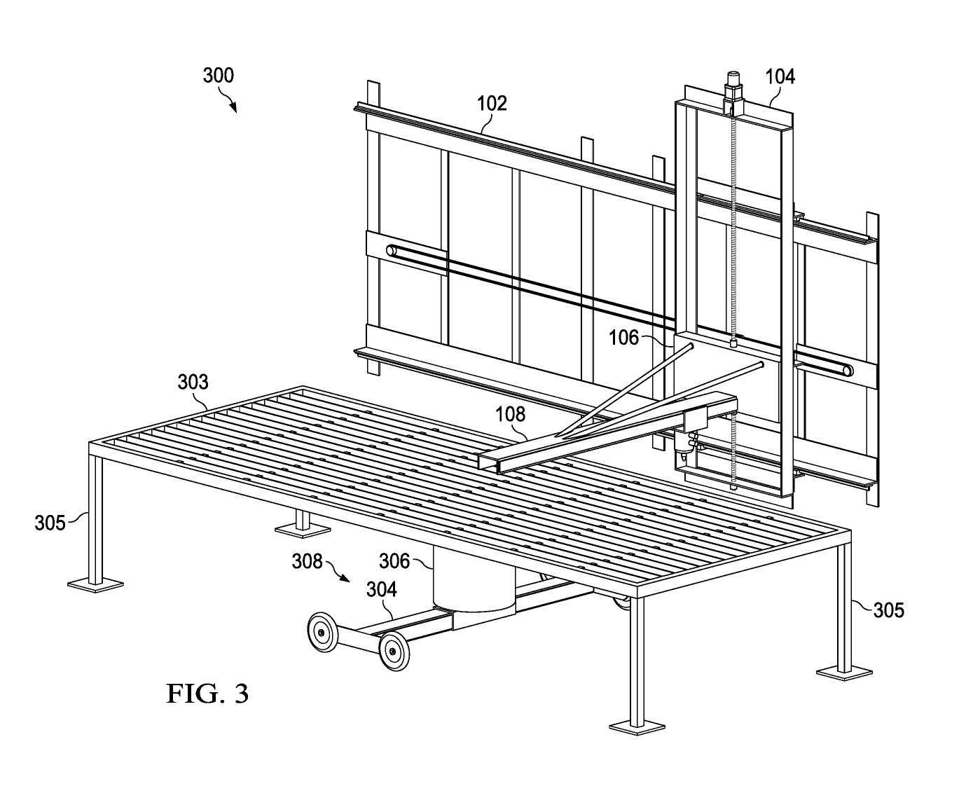

In FIG. 3, an example of a cutting system 300 is shown. Cutting system 300 may include one or more X-axis bars 102 attach to one or more surfaces (e.g., vertical surfaces, horizontal surfaces, a ground surface, and/or a ceiling surface). In this example, the one or more X-axis bars 102 are attached to a vertical surface (e.g., a wall). Further, the cutting system 300 may include one or more Z-axis frames 104 which attach to the one or more X-axis bars 102. In this example, the one or more Z-axis frames 104 are capable of movement along the one or more X-axis bars 102 via an X-axis motor 202 (see FIG. 2). In addition, the cutting system 300 may include a Z-saddle which stabilizes a Z-motor 204 (see FIG. 2). The cutting system 300 may also include one or more Y-axis bars 108 which are attached to at least one of the Z-saddle 106, the Z motor 204, and/or the one or more Z-axis frames 104. In one example, the Y-axis bars 108 include one or more tool holders 110. The one or more tool holders 110 are utilized to attach one or more tools 111 (e.g., plasma cutting machine, etc.).

In another example, cutting system 300 may include a tool chaser (e.g., torch chaser, cutting chaser, etc.) 308 which includes a capture system 306 and a movement device 304. Further, a titling device 502 may allow the capture system 306 to be tilted and/or turned upside down to empty and/or unload the capture system 306.

The tool chaser (e.g., torch chaser, cutting chaser, etc.) 308 eliminates the traditional welder/plasma table in favor of a computer-controlled capture system 306 (e.g., bucket, 1 gallon bucket, 10 gallon bucket, etc.). The capture system 306 and/or the tool chaser (e.g., torch chaser, cutting chaser, etc.) 308 is automatically positioned directly under (and/or any other relative position) the torch/welder. In one example, the capture system 306 and/or the tool chaser (e.g., torch chaser, cutting chaser, etc.) 308 is just large enough to capture gases, particulates, and/or other emissions as it follows the torch around. In another example, the capture system 306 and/or the tool chaser (e.g., torch chaser, cutting chaser, etc.) 308 is larger than needed to provide a safety margin (e.g., 1 percent bigger than the area under the torch discharge area, 2 percent bigger than the area under the torch discharge area, 5 percent bigger than the area under the torch discharge area, 10 percent bigger than the area under the torch discharge area, 20 percent bigger than the area under the torch discharge area, 30 percent bigger than the area under the torch discharge area, 50 percent bigger than the area under the torch discharge area, 75 percent bigger than the area under the torch discharge area, 90 percent bigger than the area under the torch discharge area, 100 percent bigger than the area under the torch discharge area, 125 percent bigger than the area under the torch discharge area, 200 percent bigger than the area under the torch discharge area, and/or any other amount). In various examples, tool chaser 308 removes gases, particles, wood chips, metal chips, any other element, and/or any combination thereof. In another example, tool chaser 308 works in conjunction with a vacuum system to remove gases, particles, wood chips, metal chips, any other element, and/or any combination thereof. Further, the vacuum system may remove gases, particles, wood chips, metal chips, any other element, and/or any combination thereof from the top of the work area while the tool chaser 308 removes gases, particles, wood chips, metal chips, any other element, and/or any combination thereof from the bottom area. In another example, the vacuum system may remove gases, particles, wood chips, metal chips, any other element, and/or any combination thereof from any area of the work area.

In another example, the movement device 304 may move up, down, right, and/or in the left direction. Any movement may occur in any direction and at any time. For example, the movement device 304 may move in the upper direction while also moving in the right direction.

Further, one addition may be a vacuum-based enclosure for a wood router. In another example, Computer-controlled plasma and welding systems today use a variety of methods for capturing gasses and particulates which are produced during their respective processes. The most popular methods are water-filled tables and vacuum-draft tables. Both of these methods are expensive to purchase and operate. They also require a significant amount of maintenance. The present disclosure uses a “capture” tank which in the preferred embodiment is about the size of a 1-gallon paint can. Using the same computer-controlled system (or an adjunct computer system) the small capture tank is moved directly underneath the welder or plasma torch. As a computer system moves the torch or welder, the capture tank is moved as well. The capture tank may be filled with a coolant, connected to a vacuum system, or both. The tank may also be empty.

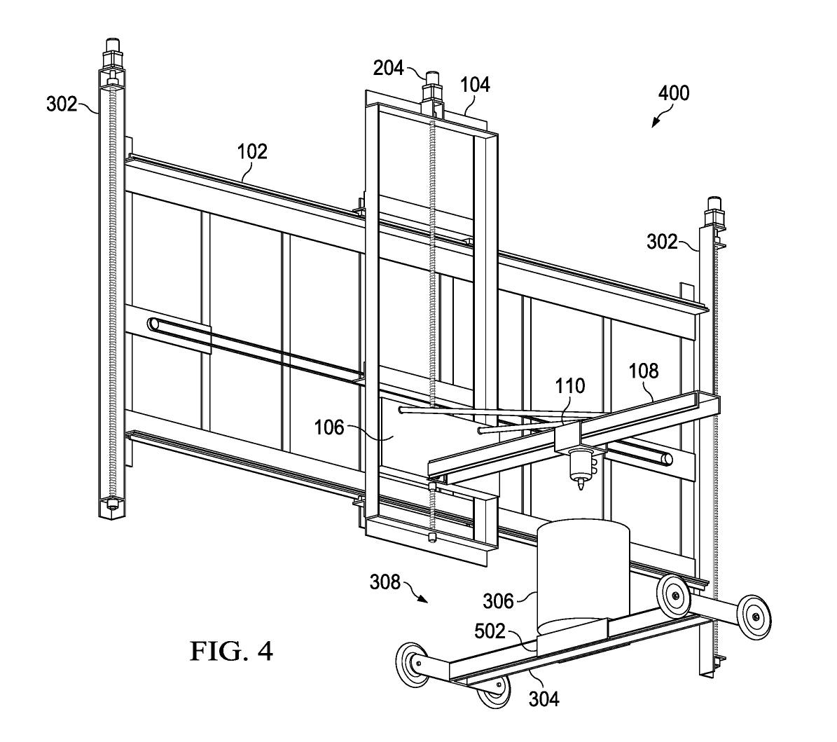

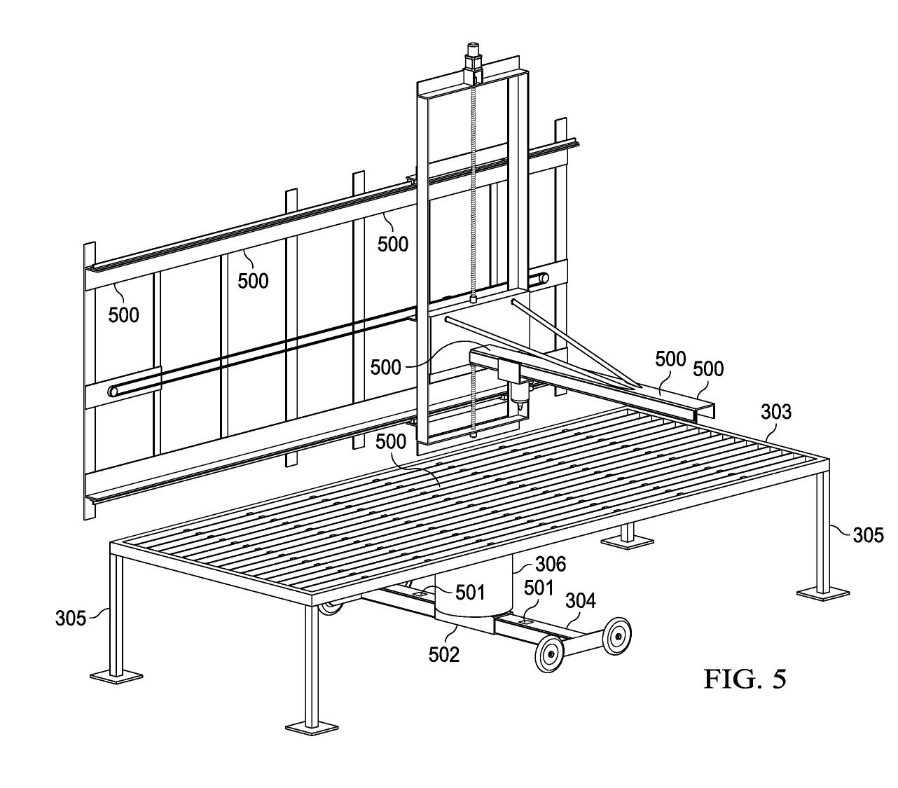

In FIG. 4-5, other views of the cutting system 300 are shown. The cutting system 300, the tool chaser (e.g., torch chaser, cutting chaser, etc.) 308, the capture system 306, and/or the movement device 304 may be made of steel, iron, copper, any other metal, glass, plastic, and/or another other material, and/or any combination thereof. Further, in FIG. 5, one or more sensors 500 may be utilized to detect objects that may be in the way of the cutting system 300. Based on an object being detected, the cutting system 300 may stop, shut down, issue a warning, avoid the object, and/or any combination thereof. Further, one or more sensors 500 may be locating in, near, and/or attached to the tool chaser (e.g., torch chaser, cutting chaser, etc.) 308, the capture system 306 and/or the movement device 304 to determine a temperature, a gas emission level, a water level, a level of particles/material in the capture system 306, and/or any combination thereof. Further, a titling device 502 may allow the capture system 306 to be tilted and/or turned upside down to empty and/or unload the capture system 306.

It should be noted that the cutting system 300, the tool chaser (e.g., torch chaser, cutting chaser, etc.) 308, the capture system 306, and/or the movement device 304 may be an integrated systems and/or standalone devices. For example, some installations may be an update/upgrade of their existing slat-based tables with a tool chaser (e.g., torch chaser, cutting chaser, etc.). In other words, traditional plasma table which they modify to accommodate a tool chaser (e.g., torch chaser, cutting chaser, etc.).

In FIG. 1, an illustration of a machining system without a table which may be used for plasma cutter, a welder, a router, a paint sprayer, or other devices is shown, according to various embodiments. FIG. 1 includes one or more X-axis bars 102 attach to one or more surfaces (e.g., vertical surfaces, horizontal surfaces, a ground surface, and/or a ceiling surface). In this example, the one or more X-axis bars 102 are attached to a vertical surface (e.g., a wall of a garage, a wall of a house, a wall of a tool shed, etc.). Further, the cutting system 100 may include one or more Z-axis frames 104 which attach to the one or more X-axis bars 102. The cutting system 100 may also include one or more Y-axis bars 108 which are attached to at least one of the Z-saddle 106, the Z motor 204 (See FIG. 2), and/or the one or more Z-axis frames 104. In one example, the Y-axis bars 108 include one or more tool holders 110. The one or more tool holders 110 are utilized to attach one or more tools 111 (e.g., plasma cutting machine, etc.). In this example, the cutting system 100 may include a vertical movement device 113 which is utilized with one or more motors and a horizontal movement device 115 which is utilized with one or more motors to move the Y-axis bars 108, the one or more tool holders 110, and/or the one or more tools 111 in the x-y plane.

In FIG. 2 another illustration of a machining system without a table which may be used for plasma cutter, a welder, a router, a paint sprayer, or other devices is shown, according to various embodiments. In this example, the cutting system 100 includes a Y-motor 206 which allows for movement along the Y-axis of the cutting system 100, a Z-motor 204 which allows for movement along the Z-axis of the cutting system 100, and the X-motor 202 which allows for movement along the X-axis of the cutting system 100. It should be noted that the configuration may be changed to have any of the motors (X-motor 202, Z-motor 204, and/or Y motor 206) create movement in any directions (e.g., X-motor can be configured for movement in the Y and/or Z direction, etc.). In other words, the X, Y, Z axis may be changed in any direction.

In various examples, the cutting system 100 may be constructed of glass, metal, plastic, wood, ceramics, polymers, and/or combination thereof. In one example, the cutting system 100 parts are made up of metal. In another example, various materials may be used. For example, part 1 could be steel, part 2 could be aluminum, part 3 could be plastic, etc. For cost savings and simplicity, the current embodiment uses easily-obtained steel angle iron to completely construct the machine.

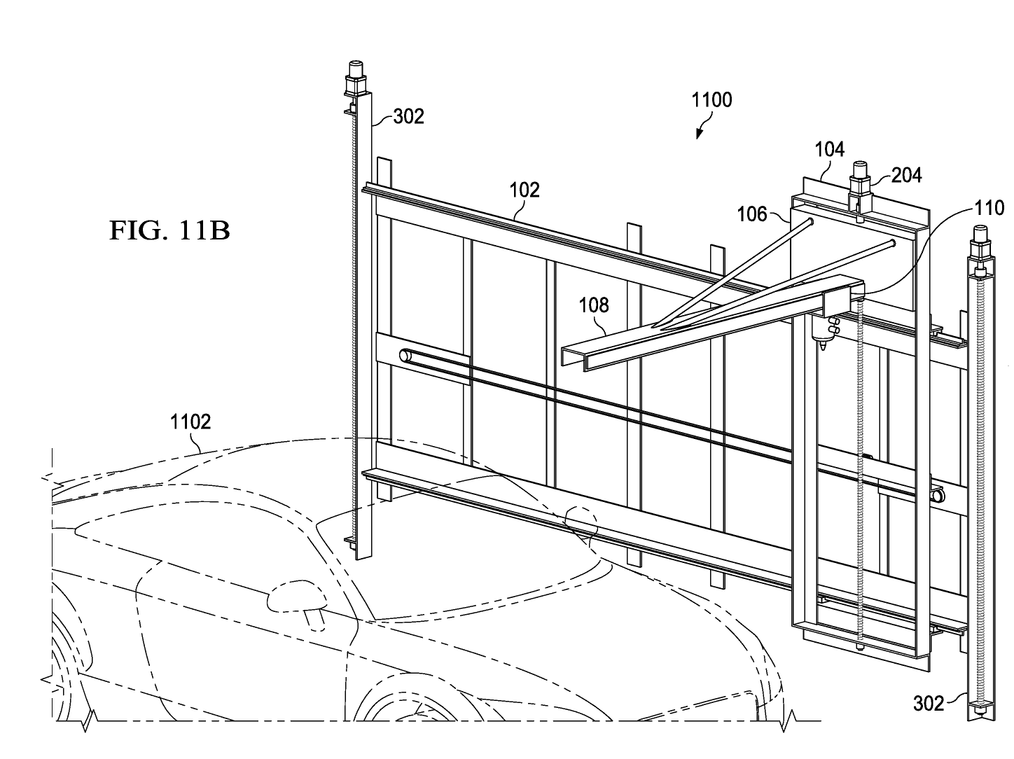

In various examples, the cutting system 100 may allow for outrageous (extreme, flexible, productive, etc.) Z-directional movement and/or travel. In one example, the Z travel's (movement, etc.) primary use is to allow the Y Axis to be moved up enough to allow objects to be located underneath it (e.g., a car to be parked underneath the cutting system 100). It also lends itself to interesting work: metal can be cut while still on a trailer or in the back of a pickup. It allows large objects to be moved under the cutter/welder. If a wood router is used as the tool, it allows existing furniture to be customized. Further, the movement devices may be used to store an object (e.g., a table) in a location that allows for other objects to be stored underneath the cutting system—a car (see FIG. 11A).

In another example, normally the Z axis of any computer numerical control (“CNC”) machine is the shortest-moving axis. For example, a CNC machine with 22″ of X, typically has 16″ of Y, and 8 to 12″ of Z. Being able to adjust the machine dynamically to fit the work is extremely useful. The way it's accomplished today is by using the cutter/welder/router by hand. The CNC machines are only used when the project is in its infancy and still consists of flat components.

In another example, the cutting system 100 may be wall mounted. This has the obvious benefits of space-saving and massive cost-reduction. In conjunction with the Z travel and the low wall profile the machine can practically disappear (requires minimal storage space) when not in use. Not having a fixed table saves a fortune in metal given that tables must hold 500-1000 lbs. to be useful. Also by having no table, the space in the machine's working envelope can be used for parking or for further assembly of a project.

In one example, the cutting system 100 may be used to cut a sunroof into a vehicle. In this example, the vehicle is driven underneath the cutting system 100 where the cutting system 100 creates an exhaust and/or any other element into the vehicle. In another example, one or more objects (e.g., heavy, light, etc.) may be positioned underneath the cutting system 100 and/or Y-axis bars 108 and/or tools located in the one or more tool holders 110 to be worked on by the cutting system 100.

Please note that this disclosure includes controlling the cutting system 100 with one or more processors to automatically cut, craft, and/or modify any object and/or element.

In another example, the one or more Y-axis bars 108 may swing towards the one or more of the Z-axis frame 104 and/or the one or more X-axis bars 102. This may be done for storage purposes. Further, the one or more Y-axis bars 108 may move up the one or more of the Z-axis frame 104 to a storage point. In addition, the one or more Y-axis bars 108 may move towards the one or more X-axis bars 102. In another example, the one or more Y-axis bars 108, the one or more of the Z-axis frame 104 and/or the one or more X-axis bars 102 may consolidate towards each other for compact storage. In another example, the one or more Y-axis bars 108 and the one or more of the Z-axis frame 104 may consolidate towards each other for compact storage while the one or more X-axis bars 102 stay stationary.

### VARIOUS EXAMPLES

Any existing structure that otherwise could not be lifted onto a traditional table either because of weight or dimension. Materials can be cut or welded while still on a delivery trailer or inside the bed of truck. Modifications to existing weldments previously had to be done by handheld cutters or welders. In conjunction with a swiveling head, the end-effector can be oriented in ways never before considered. Coupled with the massive Z axis cuts and welds can be performed in the Z axis—very novel given the X and Y are the project's usual space while the Z is only to downwardly position an end-effector. The unit can be thought of as ‘cubic’ versus the traditional X/Y flat plane.

All of these examples in this disclosure may be combined in any manner. In other words, a first element in example 1 may be combined with a second element and a third element of example 2. Further, a first element in example 1 may be combined with a third element of example 2, a fifth element of example n−1, and/or an n element from an nth example.

In FIG. 3, an illustration of a machining system with a table and a tool chaser (e.g., torch chaser, cutting chaser, etc.) which may be used for plasma cutter, a welder, a router, a paint sprayer, or other devices is shown, according to various embodiments. Cutting system 300 (and/or any other machining system) may include one or more X-axis bars 102 attach to one or more surfaces (e.g., vertical surfaces, horizontal surfaces, a ground surface, and/or a ceiling surface. In this example, the one or more X-axis bars 102 are attached to a vertical surface (e.g., a wall of a garage, a wall, etc.—further it should be noted that the vertical surface could be a horizontal surface—a ceiling or a floor or the surface may be angled). Further, the cutting system 300 (and/or any other machining system) may include one or more Z-axis frames 104 which attach to the one or more X-axis bars 102. In this example, the one or more Z-axis frames 104 are capable of movement along the one or more X-axis bars 102 via an X-axis motor 202 (see FIG. 2). In addition, the cutting system 300 (and/or any other machining system) may include a Z-saddle which stabilizes a Z-motor 204 (see FIG. 2). The cutting system 300 (and/or any other machining system) may also include one or more Y-axis bars 108 which are attached to at least one of the Z-saddle 106, the Z motor 204, and/or the one or more Z-axis frames 104. In one example, the Y-axis bars 108 include one or more tool holders 110. The one or more tool holders 110 are utilized to attach one or more tools (e.g., plasma cutting machine, etc.). Further, a table 303 may also be included in the cutting system 300 (and/or any other machining system). In addition, table 303 may be moved in any direction via table movement device. In this example, table movement device can move up, down, to the right, and/or to the left. However, additional motors can be added to table movement device to move table 303 in any direction in the xyz plane. In this example, table 303 may have one or more leveling wall supports 305.

In another example, cutting system 300 may include a tool chaser (e.g., torch chaser, cutting chaser, etc.) 308 which includes a capture system 306 and a movement device 304. The tool chaser (e.g., torch chaser, cutting chaser, etc.) 308 eliminates the traditional welder/plasma table in favor of a computer-controlled capture system 306 (e.g., bucket, 1 gallon bucket, 10 gallon bucket, etc.). The capture system 306 and/or the tool chaser (e.g., torch chaser, cutting chaser, etc.) 308 is automatically positioned directly under (and/or any other relative position) the torch/welder. In one example, the capture system 306 and/or the tool chaser (e.g., tool chaser, torch chaser, cutting chaser, etc.) 308 is just large enough to capture gases, particulates, and/or other emissions as it follows the torch around. In another example, the capture system 306 and/or the tool chaser (e.g., tool chaser, torch chaser, cutting chaser, etc.) 308 is larger than needed to provide a safety margin (e.g., 1 percent bigger than the area under the torch (e.g., torch=tool) discharge area, 2 percent bigger than the area under the torch discharge area, 3 percent bigger than the area under the torch discharge area, 4 percent bigger than the area under the torch discharge area, 5 percent bigger than the area under the torch discharge area, 6 percent bigger than the area under the torch discharge area, 7 percent bigger than the area under the torch discharge area, 8 percent bigger than the area under the torch discharge area, 9 percent bigger than the area under the torch discharge area, 10 percent bigger than the area under the torch discharge area, 20 percent bigger than the area under the torch discharge area, 30 percent bigger than the area under the torch discharge area, 50 percent bigger than the area under the torch discharge area, 75 percent bigger than the area under the torch discharge area, 90 percent bigger than the area under the torch discharge area, 100 percent bigger than the area under the torch discharge area, 125 percent bigger than the area under the torch discharge area, 200 percent bigger than the area under the torch discharge area, and/or any other amount).

In another example, the movement device 304 may move up, down, right, in the left direction and/or any angled direction. Any movement may occur in any direction and at any time. For example, the movement device 304 may move in the upper direction while also moving in the right direction.

Further, one addition may be a vacuum-based enclosure for a wood router. In another example, Computer-controlled plasma and welding systems today use a variety of methods for capturing gasses and particulates which are produced during their respective processes. The most popular methods are water-filled tables and vacuum-draft tables. Both of these methods are expensive to purchase and operate. They also require a significant amount of maintenance. The present disclosure uses a “capture” tank which in the preferred embodiment is about the size of a 1-gallon paint can. Using the same computer-controlled system (or an adjunct computer system) the small capture tank is moved directly underneath the welder or plasma torch. As a computer system moves the torch or welder, the capture tank is moved as well. The capture tank may be filled with a coolant, connected to a vacuum system, or both. The tank may also be empty.

In FIG. 4, an illustration of a machining system with a tool chaser (e.g., torch chaser, cutting chaser, etc.) and without a table which may be used for plasma cutter, a welder, a router, a paint sprayer, or other devices is shown, according to various embodiments. Cutting system 400 (and/or any other machining system) may include one or more X-axis bars 102 attach to one or more surfaces (e.g., vertical surfaces, horizontal surfaces, a ground surface, and/or a ceiling surface. In this example, the one or more X-axis bars 102 are attached to a vertical surface (e.g., a wall of a garage, a wall, etc.—further it should be noted that the vertical surface could be a horizontal surface—a ceiling or a floor or the surface may be angled). Further, the cutting system 400 (and/or any other machining system) may include one or more Z-axis frames 104 which attach to the one or more X-axis bars 102. In this example, the one or more Z-axis frames 104 are capable of movement along the one or more X-axis bars 102 via an X-axis motor 202 (see FIG. 2). In addition, the cutting system 400 (and/or any other machining system) may include a Z-saddle which stabilizes a Z-motor 204 (see FIG. 2). The cutting system 300 (and/or any other machining system) may also include one or more Y-axis bars 108 which are attached to at least one of the Z-saddle 106, the Z motor 204, and/or the one or more Z-axis frames 104. In one example, the Y-axis bars 108 include one or more tool holders 110. The one or more tool holders 110 are utilized to attach one or more tools 111 (e.g., plasma cutting machine, etc.).

In another example, cutting system 400 may include a tool chaser (e.g., torch chaser, cutting chaser, etc.) 308 which includes a capture system 306 and a movement device 304. Further, a titling device 502 may allow the capture system 306 to be tilted and/or turned upside down to empty and/or unload the capture system 306.

The tool chaser (e.g., torch chaser, cutting chaser, etc.) 308 eliminates the traditional welder/plasma table in favor of a computer-controlled capture system 306 (e.g., bucket, 1 gallon bucket, 10 gallon bucket, etc.). The capture system 306 and/or the tool chaser (e.g., torch chaser, cutting chaser, etc.) 308 is automatically positioned directly under (and/or any other relative position) the torch/welder. In one example, the capture system 306 and/or the tool chaser (e.g., torch chaser, cutting chaser, etc.) 308 is just large enough to capture gases, particulates, and/or other emissions as it follows the torch around. In another example, the capture system 306 and/or the tool chaser (e.g., torch chaser, cutting chaser, etc.) 308 is larger than needed to provide a safety margin (e.g., 1 percent bigger than the area under the torch discharge area, 2 percent bigger than the area under the torch discharge area, 3 percent bigger than the area under the torch discharge area, 4 percent bigger than the area under the torch discharge area, 5 percent bigger than the area under the torch discharge area, 6 percent bigger than the area under the torch discharge area, 7 percent bigger than the area under the torch discharge area, 8 percent bigger than the area under the torch discharge area, 9 percent bigger than the area under the torch discharge area, 10 percent bigger than the area under the torch discharge area, 20 percent bigger than the area under the torch discharge area, 30 percent bigger than the area under the torch discharge area, 50 percent bigger than the area under the torch discharge area, 75 percent bigger than the area under the torch discharge area, 90 percent bigger than the area under the torch discharge area, 100 percent bigger than the area under the torch discharge area, 125 percent bigger than the area under the torch discharge area, 200 percent bigger than the area under the torch discharge area, and/or any other amount).

In another example, the movement device 304 may move up, down, right, in the left direction and/or any angled direction. Any movement may occur in any direction and at any time. For example, the movement device 304 may move in the upper direction while also moving in the right direction.

Further, one addition may be a vacuum-based enclosure for a wood router. In another example, Computer-controlled plasma and welding systems today use a variety of methods for capturing gasses and particulates which are produced during their respective processes. The most popular methods are water-filled tables and vacuum-draft tables. Both of these methods are expensive to purchase and operate. They also require a significant amount of maintenance. The present disclosure uses a “capture” tank which in the preferred embodiment is about the size of a 1-gallon paint can. Using the same computer-controlled system (or an adjunct computer system) the small capture tank is moved directly underneath the welder or plasma torch. As a computer system moves the torch or welder, the capture tank is moved as well. The capture tank may be filled with a coolant, connected to a vacuum system, or both. The tank may also be empty.

In FIG. 4-5, other views of the cutting system 300 (and/or any other machining system) are shown. The cutting system 300 (and/or any other machining system), the tool chaser (e.g., torch chaser, cutting chaser, etc.) 308, the capture system 306, and/or the movement device 304 may be made of steel, iron, copper, any other metal, glass, plastic, and/or another other material, and/or any combination thereof. Further, in FIG. 5, one or more sensors 500 may be utilized to detect objects that may be in the way of the cutting system 300 (and/or any other machining system and/or the tool chaser (e.g., torch chaser, cutting chaser, etc.) 308, the capture system 306 and/or the movement device 304, etc.). Based on an object being detected, the cutting system 300 (and/or any other machining system) may stop, shut down, issue a warning, avoid the object, remove the object via a removal device, and/or any combination thereof. Further, one or more sensors 500 may be locating in, near, and/or attached to the tool chaser (e.g., torch chaser, cutting chaser, etc.) 308, the capture system 306 and/or the movement device 304 to determine a temperature, a gas emission level, a water level, a level of particles/material in the capture system 306, and/or any combination thereof. Further, a titling device 502 may allow the capture system 306 to be tilted and/or turned upside down to empty and/or unload the capture system 306. In addition, a tool chaser (e.g., torch chaser, cutting chaser, etc.) sensor 501 may be utilized which is a specialized sensors (e.g., temperature (e.g., needs to be cooled down—stopping machine, water cooled, air cooled, etc.), speed, location (e.g., object in the way), fumes (e.g., excessive concentration of x gas), full (e.g., needs to be emptied), any other criteria, and/or any combination thereof for the needs of the tool chaser (e.g., torch chaser, cutting chaser, etc.) 308. Further, any other device (e.g., vacuum, movement device, cutting system, plasma system, table, tool, and/or any device disclosed in this disclosure) in this disclosure may have similar sensors with similar functions for that specific device.

It should be noted that the cutting system 300 (and/or any other machining system), the tool chaser (e.g., tool chaser, torch chaser, cutting chaser, etc.) 308, the capture system 306, and/or the movement device 304 may be an integrated systems and/or standalone devices. For example, some installations may be an update/upgrade of their existing slat-based tables with a tool chaser (e.g., torch chaser, cutting chaser, etc.). In other words, traditional plasma table which they modify to accommodate a tool chaser (e.g., torch chaser, cutting chaser, etc.). Further, a table 303 may also be included in the cutting system 300 (and/or any other machining system). In addition, table 303 may be moved in any direction via table movement device. In this example, table movement device can only move up and down. However, additional motors can be added to table movement device to move table 303 in any direction in the xyz plane.

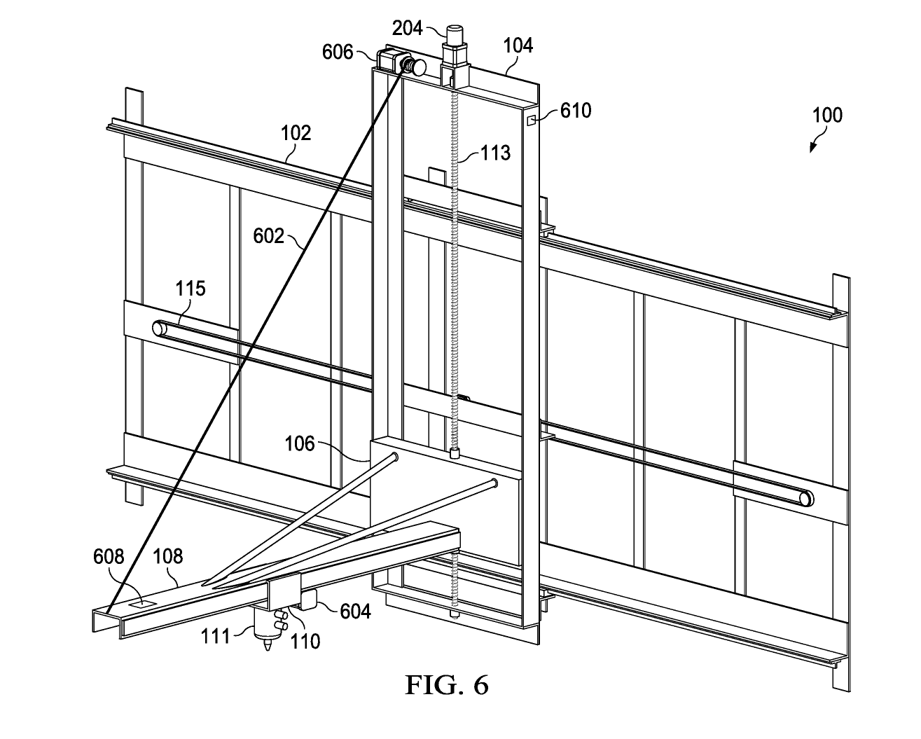

In FIG. 6, an illustration of a machining system without a table which may be used for plasma cutter, a welder, a router, a paint sprayer, or other devices is shown, according to various embodiments. FIG. 6 includes one or more X-axis bars 102 attach to one or more surfaces (e.g., vertical surfaces, horizontal surfaces, a ground surface, and/or a ceiling surface). In this example, the one or more X-axis bars 102 are attached to a vertical surface (e.g., a wall of a garage, a wall of a house, a wall of a tool shed, etc.). Further, the cutting system 100 may include one or more Z-axis frames 104 which attach to the one or more X-axis bars 102. The cutting system 100 may also include one or more Y-axis bars 108 which are attached to at least one of the Z-saddle 106, the Z motor 204 (See FIG. 2), and/or the one or more Z-axis frames 104. In one example, the Y-axis bars 108 include one or more tool holders 110. The one or more tool holders 110 are utilized to attach one or more tools 111 (e.g., plasma cutting machine, etc.). In this example, the cutting system 100 may include a vertical movement device 113 which is utilized with one or more motors and a horizontal movement device 115 which is utilized with one or more motors to move the Y-axis bars 108, the one or more tool holders 110, and/or the one or more tools 111 in the x-y plane. In addition, the cutting system 100 (and/or any other machining system) may include a Z-saddle which stabilizes a Z-motor 204 (see FIG. 2). The cutting system 100 (and/or any other machining system) may also include one or more Y-axis bars 108 which are attached to at least one of the Z-saddle 106, the Z motor 204, and/or the one or more Z-axis frames 104. In one example, the Y-axis bars 108 include one or more tool holders 110. The one or more tool holders 110 are utilized to attach one or more tools 111 (e.g., plasma cutting machine, etc.). Further, a table 303 may also be included in the cutting system 300 (and/or any other machining system). In addition, table 303 may be moved in any direction via table movement device 302. In this example, table movement device 302 can only move up and down. However, additional motors can be added to table movement device 302 to move table 303 in any direction in the xyz plane.

In addition, the cutting system 100 (and/or any other machining system) may also include a tool platform movement and support device 602 which may move via a tool platform movement device 606 (e.g., a motor, etc.). Further, the cutting system 100 (and/or any other machining system) may also include a tool movement device 604 which moves the tool 111 along the tool platform movement and support device 602 in any direction (e.g., right, left in this configuration but up and down and/or an angle if the tool platform movement and support device 602 is shaped differently (e.g., L shape, S shape, E shape, T shape, etc.)). In other words, based on the shape of the tool platform movement and support device 602, the tool 111 can move along it by utilizing tool movement device 604. In addition, a first sensor 608 and an Nth sensor 610 may be utilized to move the tool platform movement and support device 602 into a storage position and/or any other position.

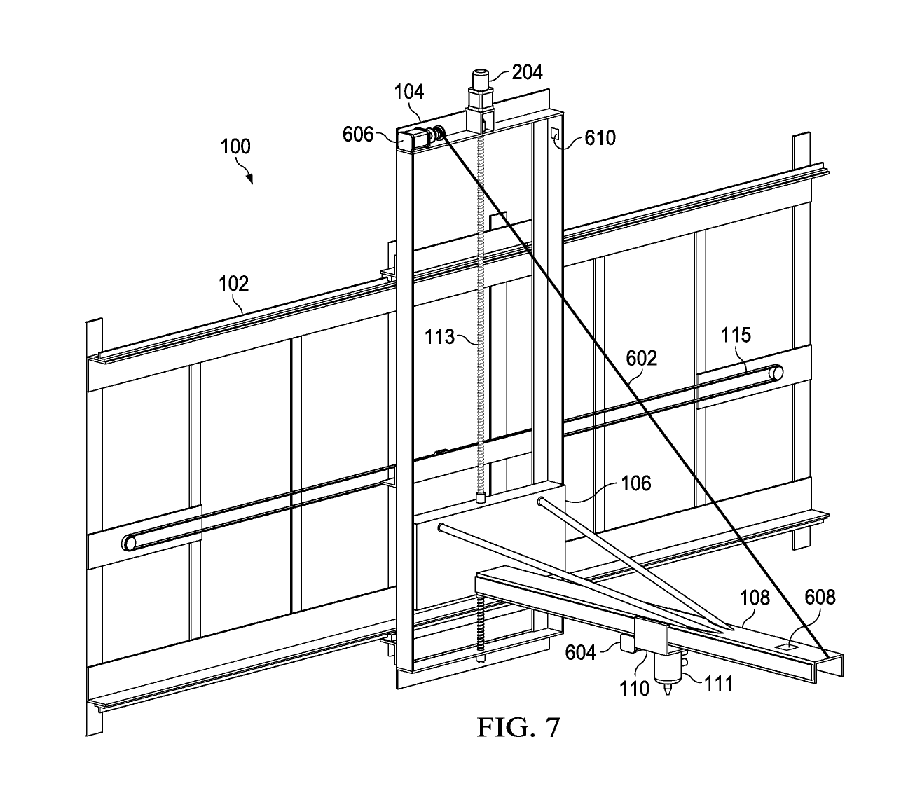

In FIG. 7, an illustration of a machining system without a table which may be used for plasma cutter, a welder, a router, a paint sprayer, or other devices is shown, according to various embodiments. In addition, the cutting system 100 (and/or any other machining system) may also include a tool platform movement and support device 602 which may move via a tool platform movement device 606 (e.g., a motor, etc.). Further, the cutting system 100 (and/or any other machining system) may also include a tool movement device 604 which moves the tool 111 along the tool platform movement and support device 602 in any direction (e.g., right, left in this configuration but up and down and/or an angle if the tool platform movement and support device 602 is shaped differently (e.g., L shape, S shape, E shape, T shape, etc.)). In other words, depending on the shape of the tool platform movement and support device 602, the tool 111 can move along it by utilizing tool movement device 604. In addition, a first sensor 608 and an Nth sensor 610 may be utilized to move the tool platform movement and support device 602 into a storage position and/or any other position.

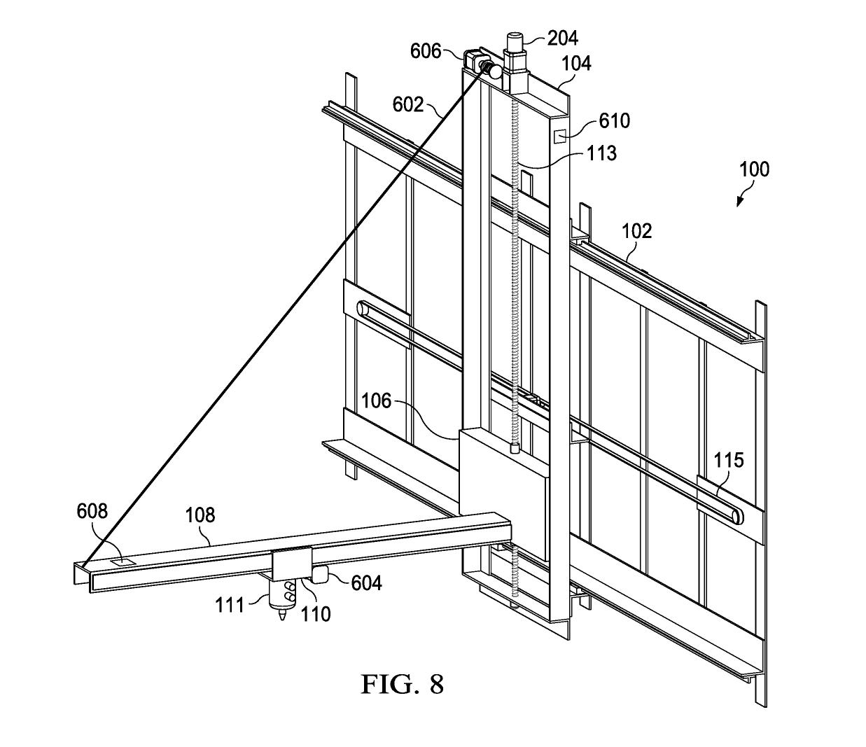

In FIG. 8, an illustration of a machining system without a table which may be used for plasma cutter, a welder, a router, a paint sprayer, or other devices is shown, according to various embodiments. In addition, the cutting system 100 (and/or any other machining system) may also include a tool platform movement and support device 602 which may move via a tool platform movement device 606 (e.g., a motor, etc.). Further, the cutting system 100 (and/or any other machining system) may also include a tool movement device 604 which moves the tool 111 along the tool platform movement and support device 602 in any direction (e.g., right, left in this configuration but up and down and/or an angle if the tool platform movement and support device 602 is shaped differently (e.g., L shape, S shape, E shape, T shape, etc.)). In other words, what the shape of the tool platform movement and support device 602, the tool 111 can move along it by utilizing tool movement device 604. In addition, a first sensor 608 and an Nth sensor 610 may be utilized to move the tool platform movement and support device 602 into a storage position and/or any other position.

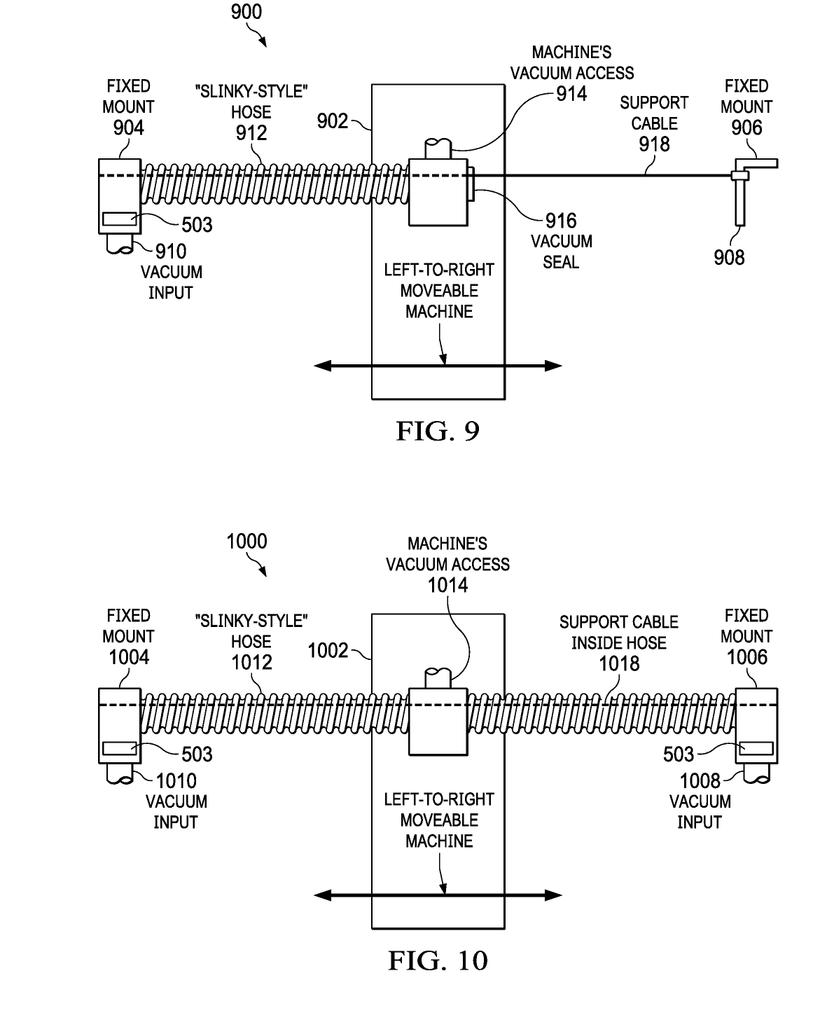

In FIG. 9, an illustration of a vacuum system is shown, according to an embodiment. A vacuum system 900 may include a vacuum, a first mount device 904 (e.g., fixed mount device and/or adjustable mount device), a second mount device 906 (e.g., fixed mount device and/or adjustable mount device), a first vacuum input area 908, a second vacuum input area 910, an Nth vacuum input area (not shown but may be anywhere on vacuum system 900), a hose 912 (e.g., slinky-style hose, and/or any other type of hose), a machine's vacuum access area 914, a vacuum seal 916, and/or one or more support cables 918. Further, the vacuum system 900 and/or one or more of the vacuum system's parts may move left-to-right on the X axis which relates to the Z axis (see reference number 902). In this example, the vacuum system 900 may move in a right direction and/or a left direction. However, in various embodiments, vacuum system 900 may move up, move down, move at an angle, move to the right, move to the left, tilt, invert, and/or any combination thereof. In this example, vacuum input is converted to an air-hose input and pressurized air is delivered via the hose instead. In one example, a vacuum sensor 503 may be utilized which is designed for the needs (e.g., location, amount of pressure, temperature, air flow, full, etc.) of the vacuum. In one example, there may be two fixed points, one at the either end of the machine's travel. In one example, the vacuum hose may be fixed to one such fixed point and the other end of the vacuum hose is attached to the moveable part of the machine. In addition, a cable is run from one fixed point to the other fixed point, through an attachment on the moveable part of the machine. The cable may be buried inside the hose. In addition, when the machine is moving, the vacuum hose expands and contracts with the moveable part but is kept orderly by the internal cable. In addition, the one fixed end for the vacuum hose attachment, terminating into another attachment on the moveable part which allows the support cable to continue to the other fixed point. In addition, a seal around the cable prevents vacuum leakage. In another example, the two fixed points on either end are identical. The vacuum hose is attached to both, and then each terminates on the moveable part of the machine. In addition, this has the advantage of allowing the vacuum source to be introduced at either end of the machine.

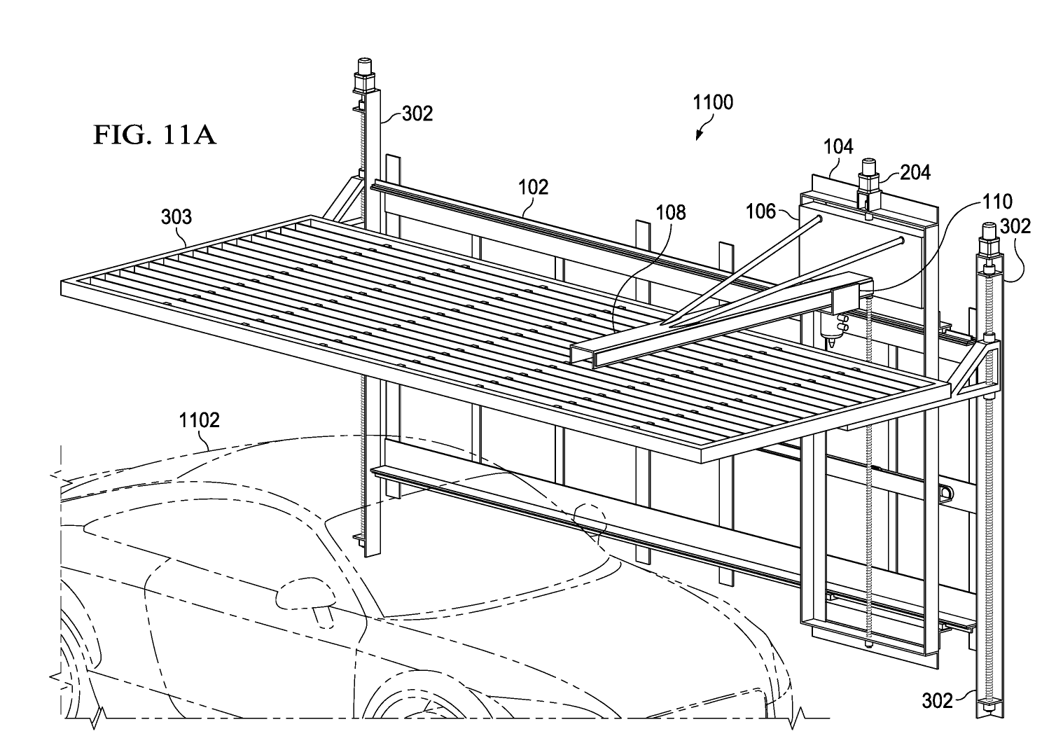

In FIG. 10, an illustration of a vacuum system is shown, according to an embodiment. A vacuum system 1000 may include a vacuum, a first mount device 1004 (e.g., fixed mount device and/or adjustable mount device), a second mount device 1006 (e.g., fixed mount device and/or adjustable mount device), a first vacuum input area 1008, a second vacuum input area 1010, an Nth vacuum input area (not shown but may be anywhere on vacuum system 900), a hose 1012 (e.g., slinky-style hose, and/or any other type of hose), a machine's vacuum access area 1014, a vacuum seal (not shown), and/or one or more support cables 1018. Further, the vacuum system 1000 and/or one or more of the vacuum system's parts may move left-to-right on the X axis which relates to the Z axis (see reference number 1002). In this example, the vacuum system 1000 may move in a right direction and/or a left direction. However, in various embodiments, vacuum system 1000 may move up, move down, move at an angle, move to the right, move to the left, tilt, invert, and/or any combination thereof. Vacuum input is converted to an air-hose input and pressurized air is delivered via the hose instead, according to various embodiments.

In FIG. 11A, an illustration of a machining system with a table which may be used for plasma cutter, a welder, a router, a paint sprayer, or other devices is shown, according to various embodiments. Cutting system 1100 (and/or any other machining system) may include one or more X-axis bars 102 attach to one or more surfaces (e.g., vertical surfaces, horizontal surfaces, a ground surface, and/or a ceiling surface. In this example, the one or more X-axis bars 102 are attached to a vertical surface (e.g., a wall of a garage, a wall, etc.—further it should be noted that the vertical surface could be a horizontal surface—a ceiling or a floor or the surface may be angled). Further, the cutting system 300 (and/or any other machining system) may include one or more Z-axis frames 104 which attach to the one or more X-axis bars 102. In this example, the one or more Z-axis frames 104 are capable of movement along the one or more X-axis bars 102 via an X-axis motor 202 (see FIG. 2). In addition, the cutting system 1100 (and/or any other machining system) may include a Z-saddle which stabilizes a Z-motor 204 (see FIG. 2). The cutting system 300 (and/or any other machining system) may also include one or more Y-axis bars 108 which are attached to at least one of the Z-saddle 106, the Z motor 204, and/or the one or more Z-axis frames 104. In one example, the Y-axis bars 108 include one or more tool holders 110. The one or more tool holders 110 are utilized to attach one or more tools 111 (e.g., plasma cutting machine, etc.). Further, a table 303 may also be included in the cutting system 300 (and/or any other machining system). In addition, table 303 may be moved in any direction via table movement device 302. In this example, table movement device 302 can only move up and down. However, additional motors can be added to table movement device 302 to move table 303 in any direction in the xyz plane. In this example, table movement device 302 has moved table 303 to a first position (e.g., storage position) which allows an object 1102 (e.g., car) to be stored underneath table 303. First position can be any position (e.g., a horizontal position right up to and adjacent to a ceil, a horizontal position removed from the ceiling by ½ an inch, 1 inch, 1½ inches, 2 inches, 2½ inches, 3 inches, 5 inches, a foot, etc. First position may be in a vertical position close and/or adjacent to the wall, a vertical position removed from the wall by ½ an inch, 1 inch, 1½ inches, 2 inches, 2½ inches, 3 inches, 5 inches, a foot, etc.). In addition, one or more sensors may forbid table 303 from moving towards object 1102 which prevents accidently damage to object 1102 and/or table 303. In another example, the 8 foot by 4 foot table folds up against the wall and protrudes no more than 12 inches from the wall. In an example, once the machine is put away (e.g., stored) the machine is overhead at 8 feet and also protrudes no more than 12 inches for the wall (and/or any wall). In addition, the machine can be built with an envelope the size of a garage door frame.

In another example, cutting system 1100 may include a tool chaser (e.g., torch chaser, cutting chaser, etc.) 308 which includes a capture system 306 and a movement device 304. The tool chaser (e.g., torch chaser, cutting chaser, etc.) 308 eliminates the traditional welder/plasma table in favor of a computer-controlled capture system 306 (e.g., bucket, 1 gallon bucket, 10 gallon bucket, etc.). The capture system 306 and/or the tool chaser (e.g., torch chaser, cutting chaser, etc.) 308 is automatically positioned directly under (and/or any other relative position) the torch/welder. In one example, the capture system 306 and/or the tool chaser (e.g., torch chaser, cutting chaser, etc.) 308 is just large enough to capture gases, particulates, and/or other emissions as it follows the torch around. In another example, the capture system 306 and/or the tool chaser (e.g., torch chaser, cutting chaser, etc.) 308 is larger than needed to provide a safety margin (e.g., 1 percent bigger than the area under the torch discharge area, 2 percent bigger than the area under the torch discharge area, 3 percent bigger than the area under the torch discharge area, 4 percent bigger than the area under the torch discharge area, 5 percent bigger than the area under the torch discharge area, 6 percent bigger than the area under the torch discharge area, 7 percent bigger than the area under the torch discharge area, 8 percent bigger than the area under the torch discharge area, 9 percent bigger than the area under the torch discharge area, 10 percent bigger than the area under the torch discharge area, 20 percent bigger than the area under the torch discharge area, 30 percent bigger than the area under the torch discharge area, 50 percent bigger than the area under the torch discharge area, 75 percent bigger than the area under the torch discharge area, 90 percent bigger than the area under the torch discharge area, 100 percent bigger than the area under the torch discharge area, 125 percent bigger than the area under the torch discharge area, 200 percent bigger than the area under the torch discharge area, and/or any other amount).

In another example, the movement device 304 may move up, down, right, in the left direction and/or any angled direction. Any movement may occur in any direction and at any time. For example, the movement device 304 may move in the upper direction while also moving in the right direction.

Further, one addition may be a vacuum-based unit for a wood router. In another example, Computer-controlled plasma and welding systems today use a variety of methods for capturing gasses and particulates which are produced during their respective processes. The most popular methods are water-filled tables and vacuum-draft tables. Both of these methods are expensive to purchase and operate. They also require a significant amount of maintenance. The present disclosure uses a “capture” tank which in the preferred embodiment is about the size of a 1-gallon paint can. Using the same computer-controlled system (or an adjunct computer system) the small capture tank is moved underneath the welder or plasma torch. In one example, the capture tank may be moved directly underneath the welder or plasma torch. In another example, the capture tank may be moved close to (e.g., slightly offset (e.g., 1%, 2%, 3%, 4%, 5%, 10%, 20%, etc.)) but not directly underneath the welder or plasma torch. For example, the chaser may be offset from the tool due to high-velocity debris ejection, as with a wood router. As a computer system moves the torch or welder, the capture tank is moved as well. The capture tank may be filled with a coolant, connected to a vacuum system, or both. The tank may also be empty.

In FIG. 11B, an illustration of a machining system with a table which may be used for plasma cutter, a welder, a router, a paint sprayer, or other devices is shown, according to various embodiments. FIG. 11B is similar to FIG. 11A but there is no table 303. In this example, tool platform movement and support device 602 which may move via a tool platform movement device 606 (e.g., a motor, etc.) has moved tool platform movement and support device 602 to a first position (e.g., storage position) which allows an object 1102 (e.g., car) to be stored underneath tool platform movement and support device 602. First position can be any position include a horizontal position right up to and adjacent to a ceil, a horizontal position removed from the ceiling by ½ an inch, 1 inch, 1½ inches, 2 inches, 2½ inches, 3 inches, 5 inches, a foot, etc. First position may be in a vertical position close and/or adjacent to the wall, a vertical position removed from the wall by ½ an inch, 1 inch, 1½ inches, 2 inches, 2½ inches, 3 inches, 5 inches, a foot, etc. In addition, one or more sensors may forbid tool platform movement and support device 602 from moving towards object 1102 which prevents accidently damage to object 1102 and/or tool platform movement and support device 602.

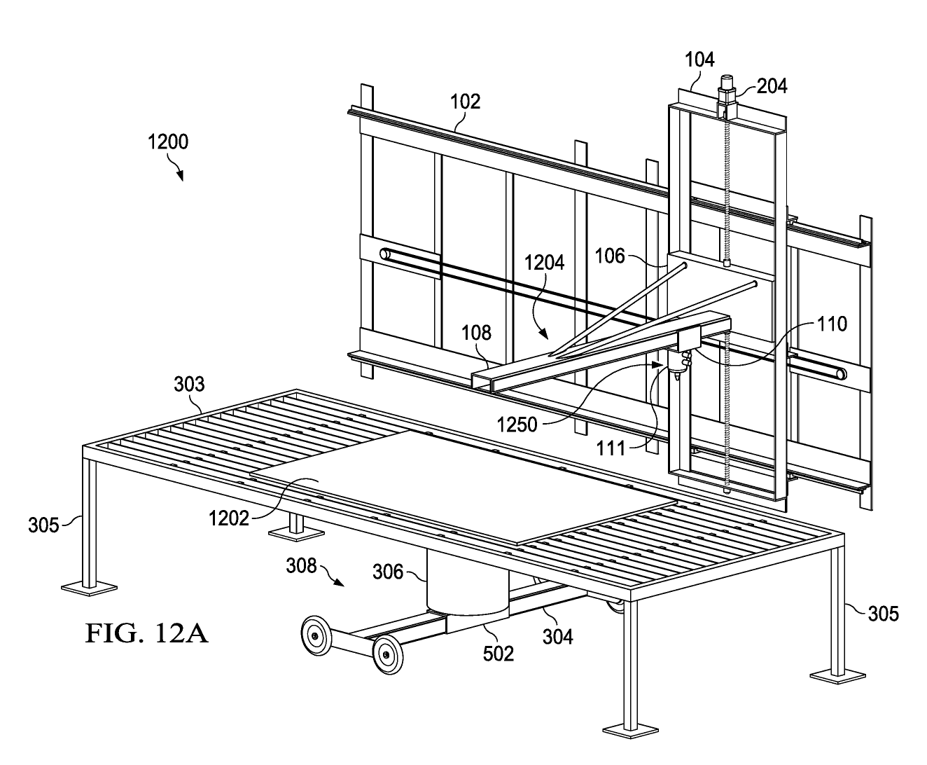

In FIG. 12A, an illustration of a machining system with a table and a tool chaser (e.g., torch chaser, cutting chaser, etc.) which may be used for plasma cutter, a welder, a router, a paint sprayer, or other devices is shown, according to various embodiments. In this example, an xyz machine 1200 has a first working object 1202 placed on a table 303 with the tool platform movement and support device 602 in a first position 1204 and the tool 111 in a first tool position 1250. The tool platform movement and support device 602 moves to a second position 1206 and the tool 111 moves to a second tool position 1252 (see FIG. 12B). Further, the tool platform movement and support device 602 moves to an Nth position 1208 (and/or multiple positions to work on the first working object 1202) and the tool 111 moves to an Nth tool position 1254 (and/or multiple positions to work on the first working object 1202) (see FIG. 12C). In this example, a work 1210 is being completed on first working object 1202.

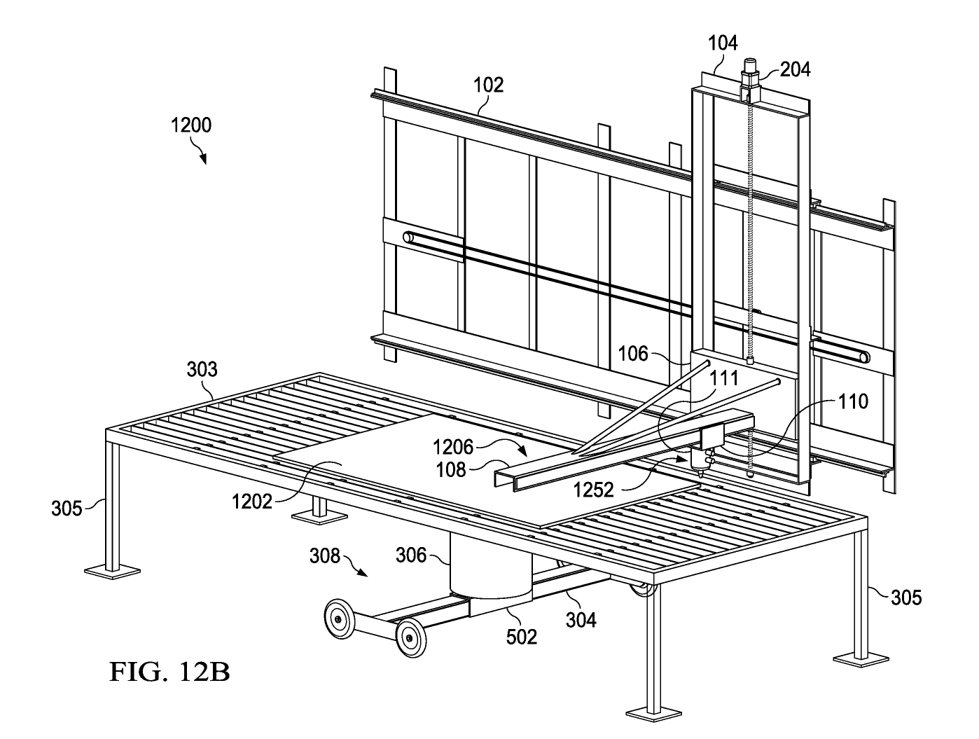

In FIG. 13, a flow chart is shown, according to one embodiment. A method 1300 may include turning on the computer controls (which may be optionally completed via one or more processors) (step 1302). The method 1300 may include activating the homing chaser (step 1304). The method 1300 may include waiting for the chaser to move to the retracted position (step 1306). The method 1300 may include disabling the chaser controller (step 1308). The method 1300 may include proceeding with normal operation of the machine (step 1310). All of these steps may be completed via one or more processors and/or one or more sensors, and/or one or more movement devices and/or one or more tools.

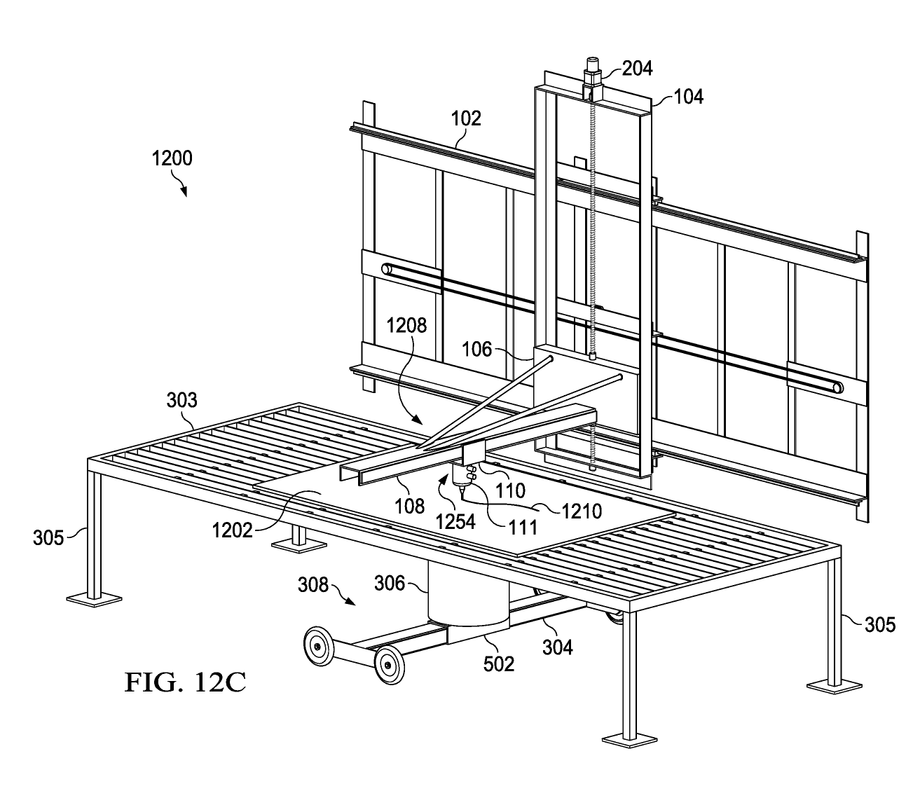

In FIG. 14, a flow chart is shown, according to one embodiment. A method 1400 may include clearing obstacles in the table area which may interfere with chaser (step 1402). The method 1400 may include turning on the computer controls (step 1404). The method 1400 may include activating the synchronize chaser (step 1406). The method 1400 may include waiting for the chaser to move into position (step 1408). The method 1400 may include proceeding with normal operations of the machine (step 1410). All of these steps may be completed via one or more processors and/or one or more sensors, and/or one or more movement devices and/or one or more tools.

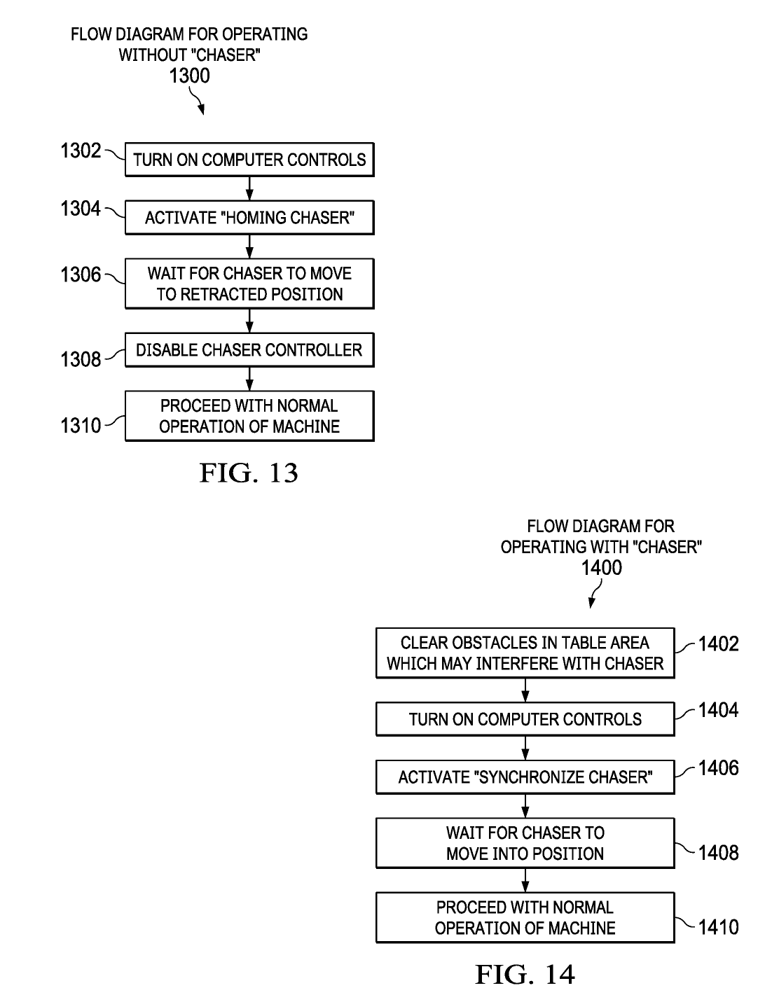

In FIG. 15, a flow chart is shown, according to one embodiment. A method 1500 may include determining whether the work object is unable to be placed upon a table (step 1502). Based on the object being able to be placed on the table, the method 1500 may include extending the table(s) into a working position (step 1504). The method 1500 may include activating or deactivating the chaser as required for the work object (step 1506). The method 1500 may include raising the Z axis to clear work object (step 1508). The method 1500 may include moving onto the table (step 1510). The method may include proceeding with normal operation of machine (step 1512). All of these steps may be completed via one or more processors and/or one or more sensors, and/or one or more movement devices and/or one or more tools.

Based on the object not being able to be placed on the table, the method 1500 may include folding the table(s) into a storage position (step 1514). The method 1500 may include turning on the computer controls (step 1516). The method 1500 may include activating the homing chaser (step 1518). The method 1500 may include waiting for the chaser to move to the retracted position (step 1520). The method 1500 may include disabling the chaser controller (step 1522). The method 1500 may include raising the Z axis to clear work object (step 1524). The method 1500 may include moving the work object inside the travel area of the machine (step 1526). The method 1500 may include proceeding with normal operation of the machine (step 1528). All of these steps may be completed via one or more processors and/or one or more sensors, and/or one or more movement devices and/or one or more tools.

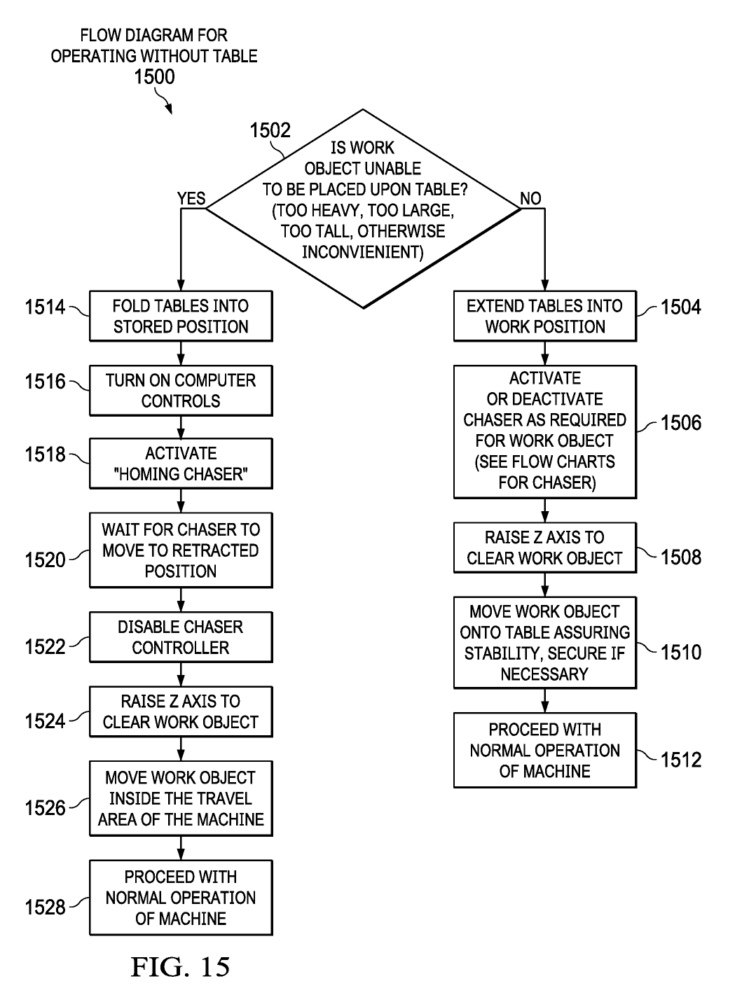

In FIG. 16, a flow chart is shown, according to one embodiment. A method 1600 may include for upper vacuum being sure Z axis tool holder has vacuum hose attached (step 1602). The method 1600 may include determining whether the chaser vacuum is required (step 1604). If the chaser vacuum is not required, then the method 1600 may move to the flow diagram in FIG. 13. If the chaser vacuum is required, then the method 1600 may move to the flow diagram in FIG. 14. Further, the method 1600 may include activating the upper and/or lower vacuum as required by the work object (step 1610). The method 1600 may include proceeding with normal operation of the machine (step 1612). All of these steps may be completed via one or more processors and/or one or more sensors, and/or one or more movement devices and/or one or more tools.

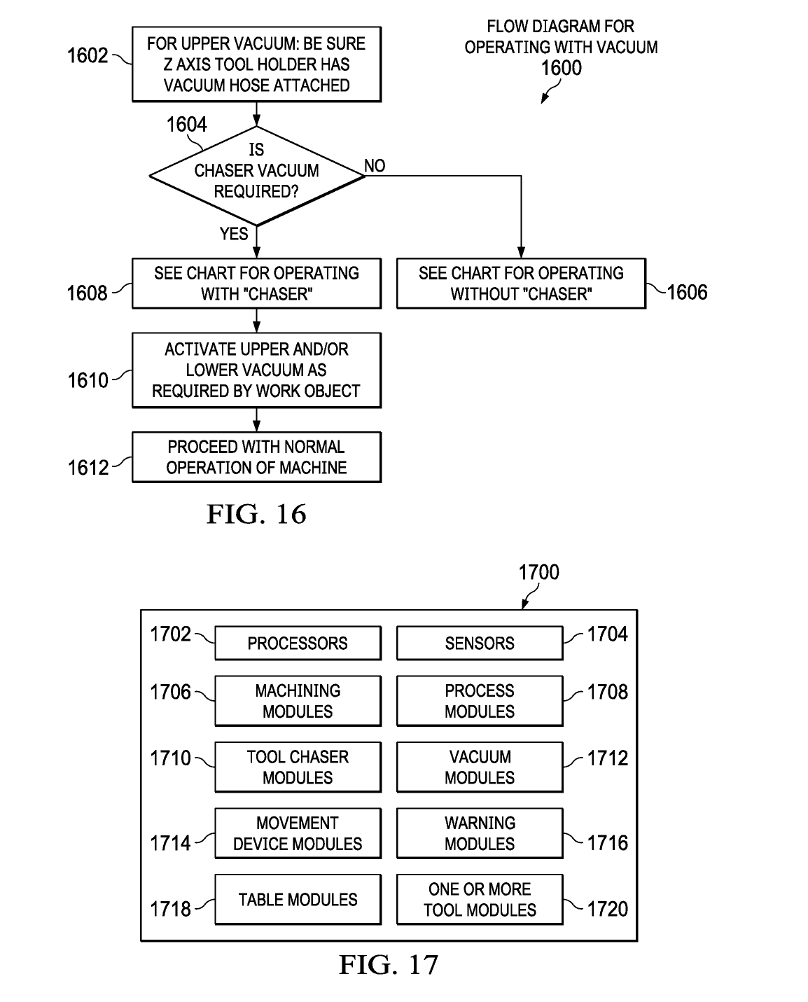

In FIG. 17 a block diagram 1700 is shown, according to one embodiment. The block diagram 1700 includes one or more processors 1702, one or more sensors 1704, one or more machining modules 1706, one or more processing modules 1708, one or more tool chaser modules 1710, one or more vacuum modules 1712, one or more movement device modules 1714, one or more warning modules 1716, one or more table modules 1718, and/or one or more tool modules 1720 which may be included in a machining system, machining device, one or more components, one or more tools, one or more external devices, one or more devices, and/or any combination thereof disclosed in this disclosure.

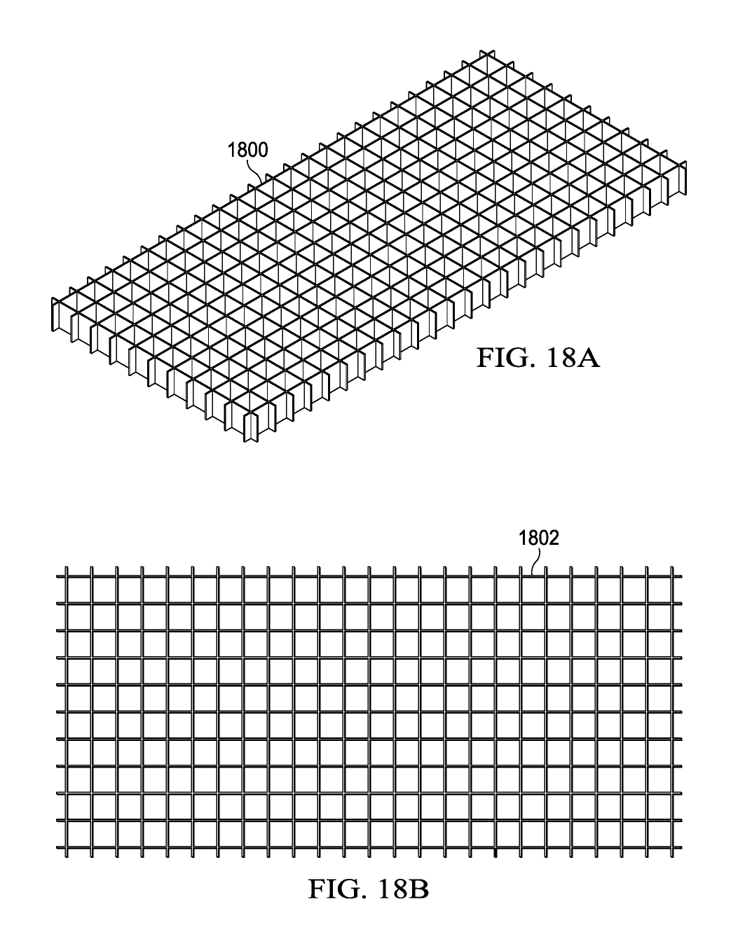

In one example, a first view 1800 of a plasma JIG is shown (FIG. 18). In another example, a second view 1802 of a plasma JIG is shown (FIG. 18).

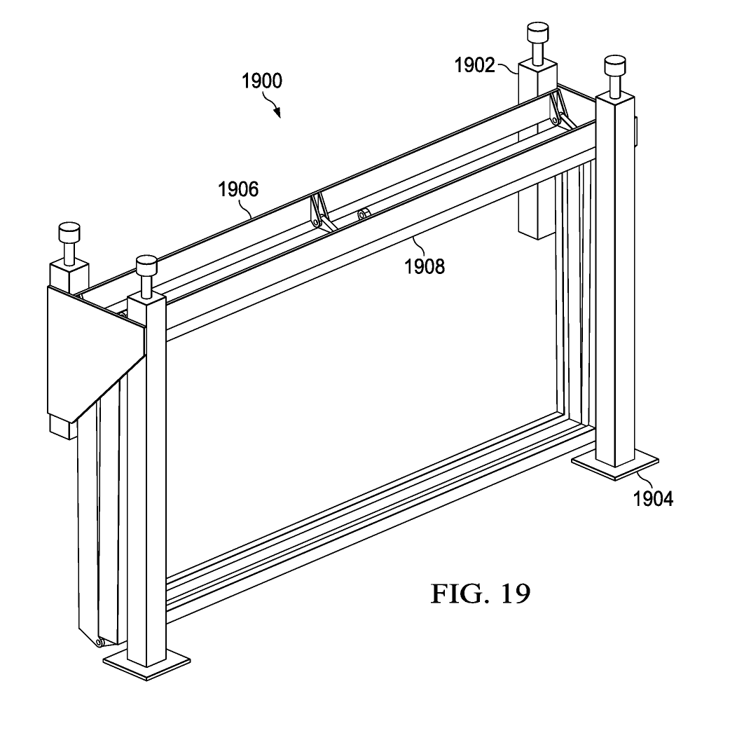

In FIG. 19 a folding work table is shown, according to one embodiment. A folding work table 1900 includes a first set of leveling wall supports 1902, a second set of leveling wall supports 1904, a first working bed 1906, and a second working bed 1908 (and/or an Nth working bed), according to one embodiment. In one example, the table would be 4 feet by 4 feet when unfolded. Further, the folding of the table may occur manually and/or via one or more motors and/or one or more processors and/or one or more sensors. Further, in various examples, the table may be 4 feet by 2 feet, 8 feet by 4 feet, 8 feet by 4 feet, and/or any other size.

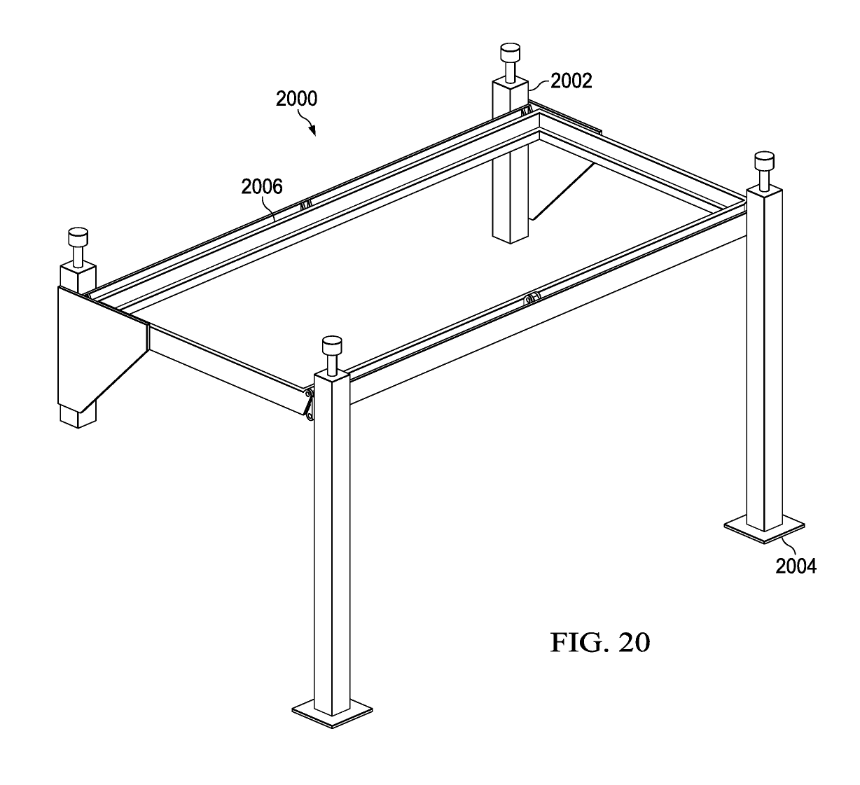

In FIG. 20 a half-table working table unfolded is shown, according to one embodiment. In this example, the unfolded table 2000 includes one or more leveling wall supports 2002 and 2004 and one or more support elements 2006 which created a bed for one or more JIGS.

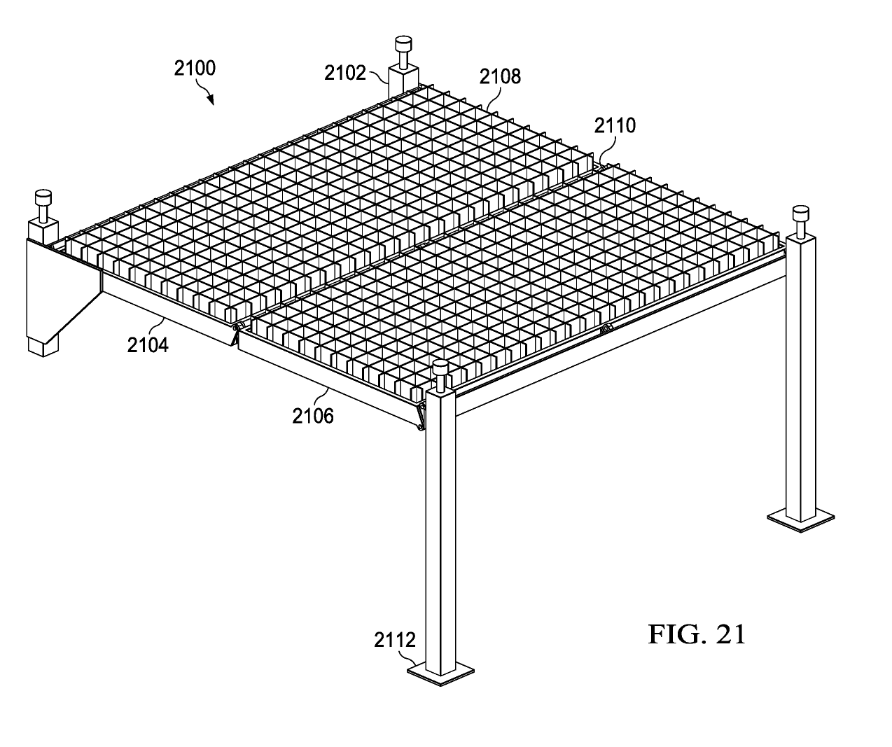

In FIG. 21 a folding work table is shown, according to one embodiment. In this example, a folding table 2100 includes a first bed 2104, a second bed 2106, one or more leveling wall supports 2102 and 2112, a first JIG 2108, and one or more hinged points 2110.

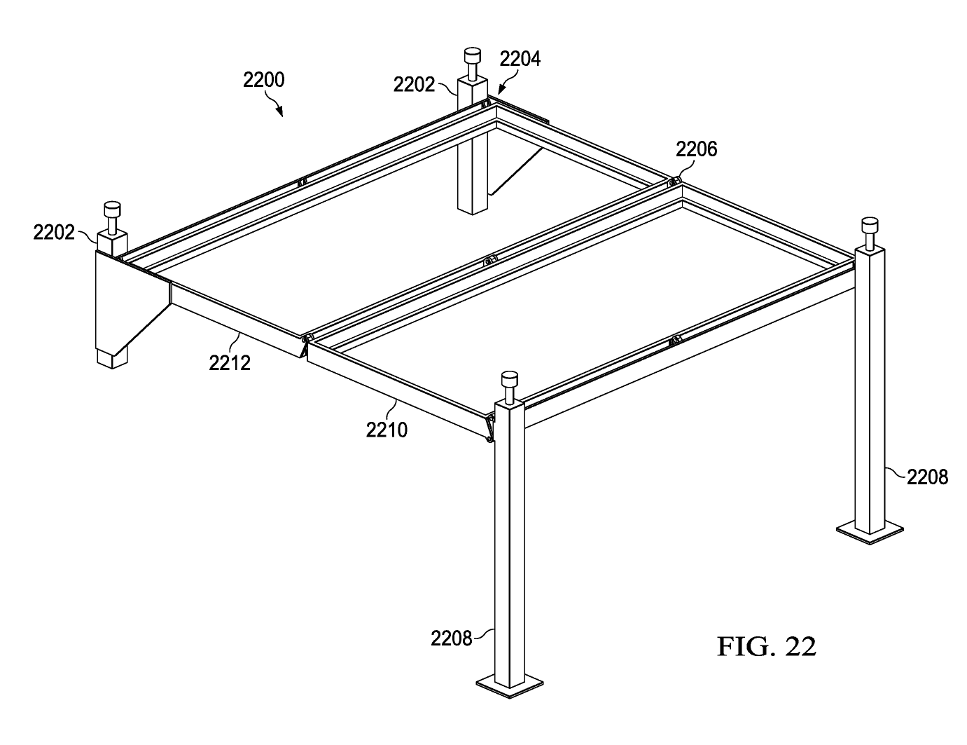

In FIG. 22, another illustration of folding work table is shown, according to one embodiment. In this example, a folding work table 2200 includes one or more leveling wall supports 2202 and 2208 (e.g., a first set of leveling wall supports and an Nth set of leveling wall supports), a first bed 2210, a second bed 2212, one or more hinge points 2206, and/or one or more rotation points 2204. The one or more hinge points 2206 and/or the one or more rotation points 2204 may be utilized to fold the table and/or set the table up via manual movement and/or electronic movement via one or more processors, one or more motors, one or more sensors, and/or any combination thereof.

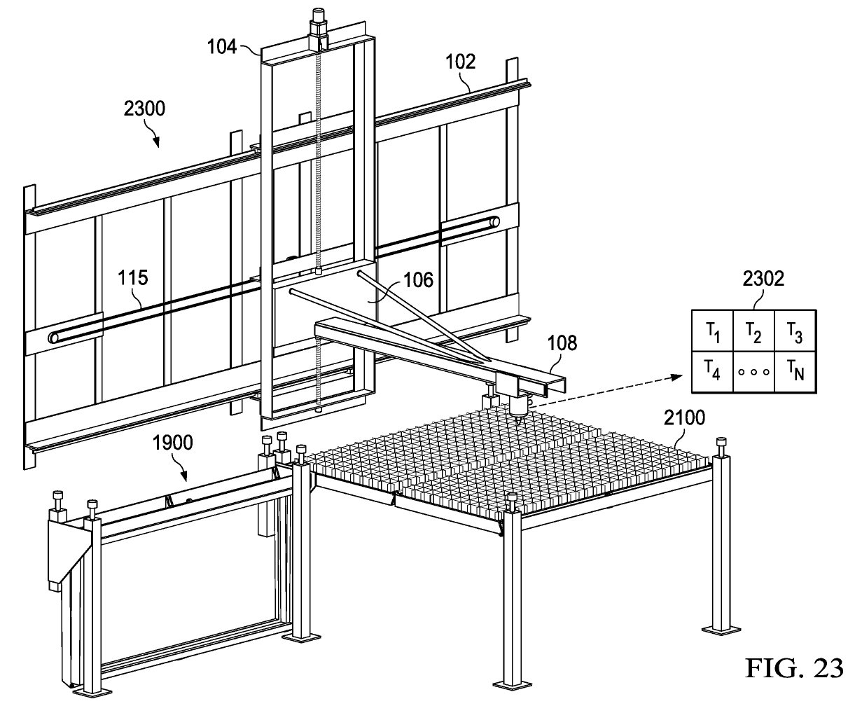

In FIG. 23, an illustration of an XYZ machine system including a half-table folding table and a folding table is shown, according to one embodiment. In this example, a machining system 2300 is shown with a machining device which includes a multiple tool attachment 2302. The multiple tool attachment 2302 may store and/or utilize one or more tools (T1, T2, T3, T4, TN) in any machining procedure. For example, a person may utilized a first tool (e.g., T1) during a project and then switch to a second tool (e.g., T2) via the multiple tool attachment 2302 without have to physically change tools and/or stop the operation because the multiple tool attachment 2302 replaces the first tool with the second tool. This may occur via one or more processors, one or more motors, one or more sensors, manually, and/or any combination thereof. In addition, the machining system 2300 includes two tables where one of the tables is in a folded position 1900 and the second table is an unfolded position 2100.

In one embodiment, a machining device (and/or a device) include one or more beams configured to be attached to a surface; a platform coupled to the one or more beams; a tool support element coupled to the platform; a first movement device which moves the platform in a first direction; a second movement device which moves the platform in a second direction; and a third movement device which moves the tool support element in a third direction.

In addition, the surface may be a wall of a garage, a wall in a room, a floor, a ceiling, an outside wall, a moveable door, a door, an angled wall, etc.

In addition, the first direction may be in a x-plane, the second direction may be in a y-plane, and the third direction may be in a z-plane. Further, the first direction may be in a y-plane, the second direction may be in a x-plane, and the third direction may be in a z-plane. In addition, the first direction may be in a z-plane, the second direction may be in a y-plane, and the third direction may be in a x-plane. Further, the first direction may be in a x-plane, the second direction may be in a z-plane, and the third direction may be in a y-plane.

In another example, the machining device may include a tool attachment unit coupled to the tool support element. In addition, the tool attachment element may be attached one or more tools to the tool support element. Further, the machining device may include a tool chaser (e.g., torch chaser, cutting chaser, etc.). In addition, the tool chaser (e.g., torch chaser, cutting chaser, etc.) may catch one or more elements removed by a tool. For example, tool chaser may capture debris from various tools. In a specific example, tool chaser may capture debris created by the use of a torch. Further, the machining device may include a table for holding an object.

In another example, the machining device may include one or more processors and one or more sensors. In addition, the one or more processors may implement one or more actions based on data obtained from the one or more sensors. Further, the one or more processors may forbid one or more actions based on data obtained from the one or more sensors.

In another example, the machining device may include one or more processors, one or more sensors, and a storage movement device where the one or more processors may move via one or more movement devices at least one of the tool support element and a table to a storage position based on data obtained from the one or more sensors.

In another example, the one or more processors may move via one or more movement devices at least one of the tool support element and the table to a start position based on data obtained from the one or more sensors. Further, the one or more processors may stop via one or more movement devices (and/or brakes) the movement to the start position of the tool support element and the table based on data obtained from the one or more sensors. In addition, the data may indicate that an object is in the way of at least one of the tool support element and the table.

In another example, the machining device may include one or more processors and one or more sensors where the one or more processors may implement one or more procedures based on data obtained from the one or more sensors. In addition, the one or more processors may stop one or more procedures based on data obtained from the one or more sensors.

In another example, the machining device may include a tool chaser (e.g., torch chaser, cutting chaser, etc.), a vacuum, one or more processors, a tool chaser (e.g., torch chaser, cutting chaser, etc.) sensor, a vacuum sensor, where the one or more processors may implement one or more tool chaser (e.g., torch chaser, cutting chaser, etc.) actions based on a first data obtained from the tool chaser (e.g., torch chaser, cutting chaser, etc.) sensor and to implement one or more vacuum actions based on a second data obtained from the vacuum sensor.

In another example, the machining device may include a vacuum device. In addition, the vacuum device may remove one or more elements (e.g., matter, liquids, solids, gases, etc.) for a work space.

In various embodiments, the tool chaser's is configured to capture from underneath debris ejected from various tools using a computer-controlled capture tank. Further, the vacuum system's is configured to have internal support cable's orderly confinement of the vacuum hose throughout the movement of the machine. In addition, the folding table's novelties along with its huge Z travel are: 1) the system doesn't need tables and can perform work not permitted by systems in use today and 2) the folding tables and large Z allow for storing the machine in such a way that the area under it can be used for other purposes, including parking a car.

In addition, despite the compact storage of the machine, it can be brought into work status in less than 5 minutes.

All locations, sizes, shapes, measurements, ratios, amounts, angles, component or part locations, configurations, dimensions, values, materials, orientations, etc. discussed above or shown in the drawings are merely by way of example and are not considered limiting and other locations, sizes, shapes, measurements, ratios, amounts, angles, component or part locations, configurations, dimensions, values, materials, orientations, etc. can be chosen and used and all are considered within the scope of the disclosure.

Dimensions of certain parts as shown in the drawings may have been modified and/or exaggerated for the purpose of clarity of illustration and are not considered limiting.

While the controllable machining device and/or tool chaser (e.g., torch chaser, cutting chaser, etc.) has been described and disclosed in certain terms and has disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

The methods and/or methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” “further,” “in addition,” and/or “another example” should be considered to mean that the particular features, structures, or characteristics may be combined in one or more examples. Any combination of any element in this disclosure with any other element in this disclosure is hereby disclosed.

While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed.

1. A machining device comprising:
one or more beams configured to be attached to a surface;
a platform coupled to the one or more beams;
a tool support element coupled to the platform;
a first movement device configured to move the platform in a first direction;
a second movement device configured to move the platform in a second direction; and
a third movement device configured to move the tool support element in a third direction.

2. The machining device of claim 1, wherein the surface is at least one of a wall and a fabrication of a wall.

3. The machining device of claim 1, wherein the first direction is in an x-plane, the second direction is in a y-plane, and the third direction is in a z-plane.

4. The machining device of claim 1, further including a tool attachment unit coupled to the tool support element.

5. The machining device of claim 4, wherein the tool attachment element is configured to attach one or more tools to the tool support element.

6. The machining device of claim 1, further including a tool chaser.

7. The machining device of claim 6, wherein the tool chaser is configured to catch one or more elements removed by a tool.

8. The machining device of claim 1, further including a table for holding an object.

9. The machining device of claim 1, further include one or more processors and one or more sensors.

10. The machining device of claim 9, wherein the one or more processors are configured to implement one or more actions based on data obtained from the one or more sensors.

11. The machining device of claim 9, wherein the one or more processors are configured to forbid one or more actions based on data obtained from the one or more sensors.

12. The machining device of claim 1, further comprising one or more processors, one or more sensors, and a storage movement device where the one or more processors are configured to move at least one of the tool support element and a table to a storage position based on data obtained from the one or more sensors.

13. The machining device of claim 12, wherein the one or more processors are configured to move at least one of the tool support element and the table to a start position based on data obtained from the one or more sensors.

14. The machining device of claim 13, wherein the one or more processors are configured to stop the movement to the start position of the tool support element and the table based on data obtained from the one or more sensors.

15. The machining device of claim 14, wherein the data indicates that an object is in the way of at least one of the tool support element and the table.

16. The machining device of claim 1, further comprising one or more processors and one or more sensors where the one or more processors are configured to implement one or more procedures based on data obtained from the one or more sensors.

17. The machining device of claim 16, wherein the one or more processors are configured to stop one or more procedures based on data obtained from the one or more sensors.

18. The machining device of claim 1, further comprising a tool chaser, a vacuum, one or more processors, a tool chaser sensor, a vacuum sensor, wherein the one or more processors are configured to implement one or more tool chaser actions based on a first data obtained from the tool chaser sensor and to implement one or more vacuum actions based on a second data obtained from the vacuum sensor.

19. The machining device of claim 1, further comprising a vacuum device.

20. The machining device of claim 1, further comprising a fold-away table.
